(19) United States
(12) Patent Application Publication
(10) Pub. No.: US 2015/0064679 A1
(43) Pub. Date: Mar. 5, 2015

(54) MOBILE CLASS MANAGEMENT

(71) Applicant: Societe BIC, Clichy Cedex (FR)

(72) Inventors: Valérie Ballestra, Orgeval (FR); Mathias Mattiuzzo, Vincennes (FR); Sylvain Giroudon, Montrouge (FR); Frèdèric Marze, La Celle Saint Could (FR)

(21) Appl. No.: 14/390,931

(22) PCT Filed: Mar. 26, 2013
(86) PCT No.: PCT/FR2013/050639

§ 371 Date: Oct. 6, 2014

(30) Foreign Application Priority Data
Apr. 6, 2012 (FR) FR1253232

(51) Int. Cl. G09B 5/12; G09B 5/02

(52) U.S. Cl. CPC G09B 5/125; G09B 5/02
USPC 434/324; 434/351

(57) ABSTRACT

An electronic system for providing assistance in teaching includes a teaching computer, a plurality of wireless tablets, a docking station arranged to receive the plurality of wireless tablets, a class configuration circuit, an educational content definition circuit, an educational session creation circuit, and an educational session management circuit. Also provided are a method performed by the system, a computer program for performing the above-specified method, and a storage medium including such a computer program.

### CROSS REFERENCE TO RELATED APPLICATIONS

This application is a national stage application of International Application No. PCT/FR2013/050639, filed on Mar. 26, 2013, which claims the benefit of French Patent Application No. 1253232 filed on Apr. 6, 2012, the entire contents of both applications being incorporated herein by reference.

### BACKGROUND OF THE INVENTION

1. Field of the Invention

The following description relates to providing electronic assistance in teaching. For example, electronic assistance may be provided for teaching young children (nursery school or primary school pupils).

2. Description of Related Art

It is typical to provide a classroom with fixed computers. Each of the pupils may thus have a computer on their desk. Typically, students having individual terminals may interact with a teacher possibly situated on a site different from the site of the students. Those approaches are not well adapted to the environment of a class of young children, giving rise to problems of managing space and organization.

Proposals have been made to replace fixed computers by tablets, which are very flat laptop computers with the majority of one of their two main faces being constituted by a screen. These tablets may be constituted in particular by conventional tablets designed for general purpose use (and not specifically for teaching young children). Numerous classes throughout the world have thus been provided with tablets. Some of those tablets have applications that enable teachers to create their own courses, and other applications that enable such courses (or various kinds of interactive manuals) to be downloaded on the tablets. Nevertheless, such tablet management remains individualized (there is no way to automate the loading of courses, which is done by parents or manually by the teacher), and the supervision of pupils while they are using tablets is minimal, being generally limited to automatically correcting exercises.

### SUMMARY OF THE INVENTION

In an aspect, an electronic system for providing assistance in teaching may include a teaching computer, a plurality of wireless tablets, each including a screen and a user identification circuit, a docking station arranged to receive the plurality of wireless tablets and to enable the batteries of the plurality of wireless tablets to be charged in parallel, a class configuration circuit arranged to define a list of pupils and at least one group of pupils selected from the pupils of the list of pupils, and to store on the teaching computer firstly the list of pupils and secondly the group(s) of pupils, an educational content definition circuit arranged to define multimedia files, each representing an educational lesson, in order to associate each of those multimedia files with at least one item of metadata enabling the multimedia files as defined in this way to be sorted, and for storing said multimedia files and the associated metadata on the teaching computer, an educational session creation circuit arranged to use multimedia files defined by the educational content definition circuit to define a subset of multimedia files suitable for use during a given educational session, to select at least one group of pupils from the group(s) defined by the class configuration circuit, to associate one or more multimedia files selected from the subset of multimedia files with each group of pupils as selected in this way, to create a session file specifying the selected groups and the multimedia file(s) associated with each of the selected groups, and to store the session file on the teaching computer, and an educational session management circuit arranged to cause a session file to be executed, the execution of the session file including, for each group specified in the session file, executing the associated multimedia file(s) and the teaching computer supervising the execution of the associated multimedia file(s), the execution of the associated multimedia file(s) including the teaching computer sending educational content corresponding to the associated multimedia file(s) to each of the wireless tablets that have, with their identification circuits, identified their users as being a pupil of the group, and each of the wireless tablets managing the educational content.

In another aspect, a method for electronically providing assistance in teaching that is performed by a system including a teaching computer, a plurality of wireless tablets, each including a screen and a user identification circuit, a docking station arranged to receive the plurality of wireless tablets and to enable the batteries of the plurality of wireless tablets to be charged in parallel, a class configuration circuit, an educational content definition circuit, an educational session creation circuit; and, an educational session management circuit, may include: the class configuration circuit defining a list of pupils and at least one group of pupils selected from the pupils of the list of pupils, and storing on the teaching computer both the list of pupils and the group(s) of pupils, the educational content definition circuit defining multimedia files, each representing an educational lesson, associating at least one item of metadata with each of these multimedia files enabling the multimedia files as defined in this way to be sorted, and storing the multimedia files and the associated metadata on the teaching computer, the educational session creation circuit using the multimedia files defined by the educational content definition circuit to define a subset of multimedia files suitable for being used during a given educational session, selecting at least one group of pupils from the group(s) defined by the class configuration circuit, associating one or more multimedia files selected from the subset of multimedia files with each group of pupils as selected in this way, creating a session file specifying the selected groups and the multimedia file(s) associated with each of the selected groups, and storing the session file on the teaching computer, and the educational session management circuit executing a session file, the execution of the session file including, for each group specified in the session file, triggering the execution of the associated multimedia file(s) and the teaching computer supervising the execution of the associated multimedia file(s), the execution of the associated multimedia file(s) including the teaching computer sending educational content corresponding to the associated multimedia file(s) to all of the wireless tablets that have, with their identification circuits, identified their users as being pupils of the group, and each of the wireless tablets managing the educational content.

For example, such a method is advantageous in that it makes it possible to provide centralized and effective management of a class of young children having such tablets.

In another aspect, a computer program includes a series of instructions performing the method when the instructions are executed by one or more processors.

In another aspect, a non-transitory computer readable storage medium includes the computer program.

These programs and storage media provide the advantages of the method together with increased flexibility compared with a purely hardware implementation (in particular modifying or updating the system can be made easier).

### BRIEF DESCRIPTION OF DRAWINGS

Other features and advantages of the invention will be apparent from the following description of several embodiments, given as non-limiting examples, with reference to the accompanying drawings in which:

FIG. 1 is a diagram illustrating an example of a system for providing electronic assistance in teaching.

FIG. 2 is a diagram illustrating an example of a method for providing electronic assistance in teaching.

### DETAILED DESCRIPTION

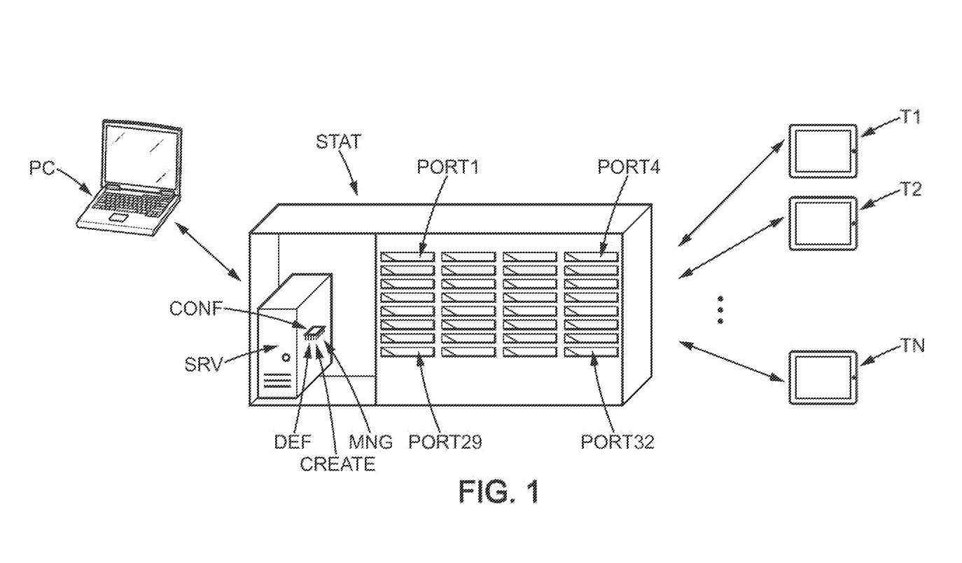

FIG. 1 is a diagram illustrating a system including a docking station STAT including a physical server SRV having a class configuration circuit CONF (constituted by the main processor of the server and a memory storing a suitable program), an educational content definition circuit DEF (constituted by the same main processor of the server and a memory storing a suitable program), an educational session creation circuit CREATE (constituted by the same main processor of the server and a memory storing a suitable program), and an educational session management circuit MNG (constituted by the same main processor of the server and by a memory storing a suitable program). The docking station STAT also has 32 ports (PORT1 to PORT32) organized in four columns, each port being arranged to receive one of the tablets T1, T2, . . . , TN. The server SRV in combination with a laptop computer PC constitutes a teaching computer suitable for managing a mobile class having the tablets T1 to TN.

One example relates to a system for providing electronic assistance in teaching.

The system includes a teaching computer. The teaching computer may be a conventional personal laptop computer having suitable software. Instead of a laptop computer, it could equally well be an office computer (having a tower, a separate screen, and a separate keyboard) together with suitable software, or any control console having suitable software. The teaching computer may also be constituted by a plurality of elements. For example, the teaching computer may be a physical server (storing the list of pupils and the handedness parameters) associated with a laptop or office computer providing a teacher with a user interface (the server not necessarily having a screen or a keyboard). The physical server may be located in the classroom, e.g. in a docking station, and may communicate with the office or laptop computer (which may for example be found on the desk of the teacher in the classroom) via a wired connection (Ethernet, etc.) or via a wireless connection (e.g. WiFi).

For example, the system includes a plurality of wireless tablets, each including a screen and a user identification circuit. These tablets can communicate with the teaching computer via wireless communication. The user identification circuit may be a processor (it may even be a processor that already exists in the tablet, such as a main processor), associated with a memory storing a program suitable for performing identification. The identification circuit may be arranged to verify with the teaching computer that the identifier which has been input does indeed correspond to a pupil in the class. The identification circuit may also be a dedicated electronic circuit, such as an application-specific integrated circuit (ASIC) or a field-programmable gate array (FPGA), or even an electronic circuit made entirely to measure, or a dedicated microcontroller. It may also include a combination of a component of the tablet together with a component of the teaching computer. The identification circuit may thus obtain a list of pupils stored in the teaching computer from a component of the teaching computer, may present this list on the screen of the touch tablet, and ask the user to click on the user's name. The circuit may also ask the users to write their names (by clicking on displayed letters or by using a keyboard). In one possible example, the identification circuit does no more than display the information transmitted by the teaching computer (e.g. a list of pupils in the form of a transmitted JPEG-format image), leaving the teaching computer to select the user (an index in a list, or the coordinates of a point selected on the screen, etc.). The teaching computer then itself determines which pupil is concerned (and optionally transfers pupil identification to a component of the identification circuit situated in the tablet). The tablet can thus be interchangeable (and not tied to any particular pupil), and thus each time pupils take tablets for an exercise that needs a tablet, they may very well use different tablets.

The system includes a docking station arranged to receive the plurality of wireless tablets and to charge in parallel the batteries of the plurality of wireless tablets. The docking station may receive other elements, such as a server of the teaching computer, a WiFi wireless access point enabling the tablets to connect with the server (or more generally with the teaching computer), an inverter, an indicator management system (for managing indicators such as light-emitting diodes (LEDs) indicating on each port of the station that receives a tablet whether the tablet is charged, charging, or out of order), etc.

The system has a class configuration circuit arranged to define a list of pupils and at least one group of pupils selected from the pupils in the list of pupils, and for storing on the teaching computer both the list of pupils and also the group(s) of pupils. The class configuration circuit may be integrated in the docking station (e.g. on a motherboard of the docking station), or it may be integrated in the teaching computer. Under such circumstances, the circuit may form part of a fixed or laptop computer used by the teacher (and may constitute all or part of the teaching computer), or it may form part of a physical server constituting all or part of the teaching computer and possibly housed in the docking station. The class configuration circuit may be a processor (it may even be a processor that already exists in the teaching computer, such as its main processor), associated with a memory storing a program suitable for performing class configuration. The class configuration circuit may also be a dedicated electronic circuit, such as an ASIC or an FPGA, or an electronic circuit made entirely to measure, or a dedicated microcontroller. It may also involve a combination of a component of a physical server (e.g. a physical server of the teaching computer, or a server that is distinct from the teaching computer) that may be housed in the station together with a component of the teaching computer (such as a screen and a processor of a laptop computer associated with software providing a graphical interface giving access to the class configuration function performed by the physical server). The class configuration circuit may include (or be associated with) a web server and may thus make its functions accessible from any computer via a web browser (e.g. a computer belonging to the teacher and situated at home). It is possible to protect access to the web server (e.g. using a password or any other suitable technique). The class configuration circuit may enable the first names and the surnames of the pupils in a class to be input and stored, together with other information associated with each pupil (e.g. a photograph, date of birth, the fact of being left- or right-handed, gender, food allergies, if any, details of parents, etc.). The class configuration circuit may enable more than one group to be created. For example: one group constituted by girls and another constituted by boys; one group constituted by all pupils born in one given calendar year (the dates of birth of the pupils in a class are generally spread over at least two distinct calendar years), groups by level (e.g. a group of good pupils, a group of average pupils, and a group of poor pupils); groups that are the result of selecting options; groups that are the result of splitting the class in half-groups (e.g. a first half-group for plastic arts on even weeks and music on odd weeks, and a second half-group for plastic arts on odd weeks and music on even weeks); etc. There is no limit on group size. In particular, it is possible to have a group with only one pupil (e.g. a pupil who arrives late, or who missed the morning, or several previous days, or a pupil having a mental and/or a motor handicap). The class configuration circuit may be used at any time. It is usable in particular during a preliminary stage, e.g. during a few days of preparation before the start of the school year that commonly takes place before the pupils go back to school (often in September), but also during the year, in particular when pupils move (changing school and thus leaving the class), new pupils arriving, pupils being welcomed on a temporary basis (foreign correspondents, or pupils from a different class in the school, etc.). Groups may also be created or modified at any time. This circuit is advantageous in particular in that it makes it possible to create groups before a teaching session so as to be in a position to start a session very quickly (e.g. by a single mouse click), while still allowing readjustments to be made during a session, where necessary (changes to groups, creating additional groups, etc.).

The system includes a circuit for defining educational contents that is arranged to define multimedia files each representing an educational lesson, in order to associate each of these multimedia files with at least one item of metadata suitable for sorting the multimedia files as defined in this way, and for storing the multimedia files and the associated metadata on the teaching computer. The definition of multimedia files may consist in creating educational contents from scratch, e.g. with a text editor or slides, a still or motion camera, video editing software, audio file editing software, etc. The definition of multimedia files may also consist in modifying existing educational contents, or in modifying templates (e.g. a writing exercise template in which the lines of writing and the instructions for the exercise are preprinted, with it being left to the teacher to complete the template with the words or letters or symbols that the pupil is to copy). The definition of multimedia files may also consist merely in selecting existing multimedia files from multimedia files available, e.g. within a library (or even in inputting such a library in full). Such a library of multimedia files may for example be integrated in the teaching computer, or it may be available on an educational content server accessible from the teaching computer.

The multimedia file containing the educational content may be a file that is directly executable. The term “directly” means that there is no need to open the file using suitable software in order to execute it, but on the contrary that the file can be executed by a processor (of a tablet, of a teaching computer, etc.) without calling on any specific software, with the file, while it is being executed and where appropriate (and at its discretion), potentially calling on an operating system (of a tablet, a teaching computer, etc.) or on specific pieces of software. In order to trigger execution of the file, it is nevertheless possible to pass via a graphical interface of dedicated software or of an operating system. By way of example, the multimedia file may be a file in the “portable executable” (PE) format, usually having an extension .EXE (where the “extension” of a file specifies the characters following the last dot included in the file name), and appropriate for a tablet having a Microsoft Windows CE operating system. For example, it may also be a file in the “executable and linkable format” (ELF) having a name that often does not have an extension (the name of the multimedia file often does not include a dot) and suitable for a tablet using a Linux operating system, or any other suitable format, depending on the type of tablet.

The metadata may include an indicator of the level for which the content is intended (for example, in France, one of the following levels PS, MS, GS, CP, CE1, CE2, CM1, and CM2, which correspond to successive years in nursery and elementary school). The data may also include an indicator about difficulty (e.g. easy, medium, or difficult), an indicator specifying the subject matter (mathematics, spelling, grammar, modern language, history, geography, plastic arts, etc.), together with indicators that are more specific (e.g. associated with a particular field in given subject matter, such as coloring water courses on a geographical map). These indicators may be cumulative, even when they belong to the same category. A given exercise may for example have educational value in several fields simultaneously (e.g. mental calculation and writing) and may thus be associated with both of these different fields. A default association of metadata may be proposed (e.g. by the multimedia file library), and the educational content definition circuit may then confirm this default association, or modify it if the teacher so desires. The multimedia files may be structured in particular using the PDF format or the HTML format (in particular HTML5). Other formats may naturally also be used (e.g. the following commonly used file formats: .DOC, .RTF, .AVI, .MP3, .OGG, .XLS, .PPT, .TXT, etc.), including proprietary formats. The multimedia files may include photos, video sequences, sound sequences, and interactive elements such as buttons enabling one answer to be selected from a plurality of suggested possible answers, drawing arrows connecting together various elements, writing over zones of educational content provided for this purpose (using a finger, a stylus, or a keyboard, possibly a virtual keyboard, i.e. one displayed on the screen), etc. An educational content represents an educational lesson, e.g. a lesson of 15 minutes devoted to mental calculation, or a half-hour writing lesson. The educational content definition circuit may be integrated in the docking station (e.g. on a motherboard of the docking station), or it may be integrated in the teaching computer. Under such circumstance, the circuit may form part of a fixed or laptop computer used by the teacher (and may constitute all or part of the teaching computer), or it may form part of a physical server constituting all or part of the teaching computer and possibly housed in the docking station. The educational content definition circuit may be a processor (it may even be a processor that already exists in the teaching computer, such as its main processor), associated with a memory storing a program suitable for performing educational content definition. The educational content definition circuit may also be a dedicated electronic circuit such as an ASIC or an FPGA, or an electronic circuit made entirely to measure, or a dedicated microcontroller. It may also involve a combination of a component of the physical server (e.g. a physical server of the teaching computer, or a server distinct from the teaching computer) that may be housed in the station together with a component of the teaching computer (such as a screen and a processor of a laptop computer associated with software providing a graphical interface giving access to the educational content definition function performed by the physical server). The educational content definition circuit may include (or be associated with) a web server and may thus make its functions accessible from any computer via a web browser (e.g. a computer belonging to the teacher and situated at home). It is possible to protect access to the web server (e.g. using a password or any other suitable technique).

The system has an educational session creation circuit arranged to use multimedia files defined by the educational content definition circuit to define a subset of multimedia files suitable for use during a given educational session. This step of defining a subset of multimedia files is distinct from the prior step of defining the multimedia files. It makes it possible subsequently to select multimedia files more simply than searching through a complete library having a much larger number of multimedia files, for example. The educational session creation circuit is arranged to select at least one group of pupils from the group(s) defined by the class configuration circuit in order to associate each group of pupils as selected in this way with one or more multimedia files selected from the subset of multimedia files in order to create a session file specifying the selected groups and the multimedia file(s) associated with each of the selected groups, and for storing the session file on the teaching computer. The session file may specify the various above-mentioned elements with an identifier for each of those elements (file name and access path, etc.), with a pointer to each of these elements (memory address, address on a hard disk, etc.), or even by reproducing these elements in full (the multimedia files may thus be copied into the session file). By means of the educational session creation circuit, a teacher can thus select the way in which a session is to be organized. In particular, it is possible to select the way in which the class is to be subdivided into groups and subgroups (where appropriate, there might be only one group including all of the pupils of the class, for example), and the educational content that is to be presented to the pupils in each group. Each group may thus receive educational content that is tailored to that group (the multimedia file(s) associated with each group may be different from the file(s) associated with other groups). It may also define a subset of multimedia files that are pertinent for the session, thereby lightening the teacher's preparation workload (in particular when it is necessary to configure a plurality of groups) by eliminating multimedia files that are not pertinent. The subset may thus be a strict subset (i.e. it may have fewer multimedia files than have been defined by the educational content definition circuit). The subset may be the result of manual selection by a teacher using an educational session creation circuit (which may for example serve to select the desired multimedia files from among all of the listed multimedia files with a mouse click), or a selection performed using selection criteria that may be used for example by the educational session creation circuit. For example, the teacher may select all of the multimedia files usable at CP level in the field of writing exercises and having an intermediate level of complexity, by selecting the metadata “CP level”, “writing exercise”, and “intermediate level” by using a graphical interface made available by the educational session creation circuit. The educational session creation circuit may then identify the multimedia files with the help of the associated metadata. In one possible example, the subset may also correspond to all of the multimedia files that the educational content definition circuit has defined. Thus, the teacher may avoid the step of inputting subset selection parameters (e.g. by clicking on a “next” button without specifying the selection criteria, or indeed by clicking on a “select all” button), leading to the entire set being selected (as the subset). This may be pertinent in particular when there is only one group of pupils during the session (the intermediate sorting manifested by selecting the subset is not necessarily justified if it is potentially for single use only), or when few multimedia files have been defined (and when isolating a narrower subset would not lead to any real saving of time). The educational session creation circuit may be integrated in the docking station (e.g. on a motherboard of the docking station), or it may be integrated in the teaching computer. Under such circumstances, the circuit may form part of a fixed or laptop computer used by the teacher (and may constitute all or part of the teaching computer), or it may form part of a physical server constituting all or part of the teaching computer and possibly housed in the docking station. The educational creation session circuit may be a processor (it may even be a processor that already exists in the teaching computer, such as its main processor), associated with a memory storing a program suitable for performing educational session creation. The educational session creation circuit may also be a dedicated electronic circuit, such as an ASIC or an FPGA, or an electronic circuit made entirely to measure, or a dedicated microcontroller. It may also involve a combination of a component of a physical server (e.g. a physical server of the teaching computer, or a server that is distinct from the teaching computer) that may be housed in the station together with a component of the teaching computer (such as a screen and a processor of a laptop computer associated with software providing a graphical interface giving access to the educational session creation function performed by the physical server). The educational session creation circuit may include (or be associated with) a web server and may thus make its functions accessible from any computer via a web browser (e.g. a computer belonging to the teacher and situated at home). It is possible to protect access to the web server (e.g. using a password or any other suitable technique). The educational session creation circuit may be arranged to associate a default multimedia file (e.g. an empty bitmap image) with tablets that would be recognized by the teaching computer, without the current user of the tablet being identified. Thus, by default, the tablets may open image management software (for drawing with a stylus). In another example, the tablets display a user identification window until a legitimate user has been identified (which may correspond to a pupil in a stored list of pupils).

The system includes an educational session management circuit arranged to execute a session file. For each group specified in the session file, the execution of the session file includes executing the associated multimedia file(s), and the teaching computer supervising the execution of the multimedia file(s). The execution of the associated multimedia file(s) includes sending educational content from the teaching computer to all of the wireless tablets that have used their identification circuit to identify their users as being pupils of the group, the educational content corresponding to the associated multimedia file(s), with the educational content then being managed by each of the wireless tablets.

The same multimedia file (containing the same educational content) may be executed at different rates by the different tablets used by the pupils in a given group. For example, a pupil working fast may finish an exercise before other pupils in the same group. Each multimedia file may be transmitted to the tablet and executed thereby. A multimedia file of PDF or HTML type may thus be executed by a PDF file reader or by a web browser installed on the tablet. The educational content is interactive content. It may include in particular exercises, to which the pupil is supposed to give answers, e.g. by clicking on the right answers from among all of the answers suggested, or by coloring a drawing, or by copying lines of writing as instructed and with a stylus. The multimedia file (e.g. an HTML or a PDF file) may include executable code such as JavaScript code that is processed by a web browser or by a PDF reader in order to provide this interactivity. In another example, each multimedia file may be executed on behalf of a tablet by means of a different entity (such as a server of the teaching computer) which may transmit the results of this execution to the tablet (i.e. the educational content, e.g. in the form of an image to be displayed on the screen at a given instant, where appropriate depending on inputs from the pupil). The educational session management circuit may be integrated in the docking station (e.g. on a motherboard of the docking station), or it may be integrated in the teaching computer. Under such circumstances, the circuit may form part of a fixed or laptop computer used by the teacher (and may constitute all or part of the teaching computer), or it may form part of a physical server constituting all or part of the teaching computer and possibly housed in the docking station. The educational session management circuit may be a processor (it may even be a processor that already exists in the teaching computer, such as its main processor), associated with a memory storing a program suitable for performing class configuration. The educational session management circuit may also be a dedicated electronic circuit, such as an ASIC or an FPGA, or an electronic circuit made entirely to measure, or a dedicated microcontroller. It may also involve a combination of a component of a physical server (e.g. a physical server of the teaching computer, or a server that is distinct from the teaching computer) that may be housed in the station together with a component of the teaching computer (such as a screen and a processor of a laptop computer associated with software providing a graphical interface giving access to the class configuration function performed by the physical server). The educational session management circuit may include (or be associated with) a web server and may thus make its functions accessible from any computer via a web browser (e.g. a computer belonging to the teacher and situated at his/her home). It is possible to protect access to the web server (e.g. using a password or any other suitable technique).

The class configuration circuit, the educational content definition circuit, the educational session creation circuit, and the educational session management circuit may share the same hardware resources (for example they may all rely on a single common processor). These circuits may be arranged to export the files they generate via a universal serial bus (USB) key (a kind of digital satchel) and enable these files to be conveyed to the teaching computer without necessarily passing via network communication with the teaching computer. In one example, the teacher can thus prepare courses at home, store the files on the USB key, and transfer them to the physical server of the teaching computer (in the classroom) merely by inserting the USB key in a USB port of the server (which may be arranged to recognize the key automatically and copy its contents into the appropriate folder without intervention on the part of the teacher).

In an example, the teaching computer is arranged to supervise the execution of one or more multimedia files for a given wireless tablet by displaying on a screen of the teaching computer a copy of the display on the wireless tablet, and by displaying on the screen of the wireless tablet information that is input in response to this display by a teacher using the teaching computer. For this purpose, each tablet may include a tool for taking control remotely via a virtual network computing (VNC) server, a Citrix server, or any system using a protocol such as RDP, ICA, RFB, or X11. The teaching computer may include a client corresponding to the server installed on the tablet (VNC client, Citrix client, etc.). The content of the screen may be transmitted as an image (possibly compressed), or with a protocol that is more elaborate. The teacher can thus interact with any of the tablets over which the teacher takes control (e.g. by using the mouse of the teaching computer on a window that reproduces the content of the tablet screen), as though the teacher had gone to the table of the pupil in question and had input information into the touch tablet using the stylus of that tablet. Even though the tables of the pupils are generally not very far away from the desk of the teacher, being able to have full control from the teacher's desk can represent a significant saving in time.

In an example, the teaching computer is arranged to virtualize the environment of each wireless tablet (e.g. with a type 1 or type 2 hypervisor) and thus execute the multimedia file(s) on behalf of each wireless tablet. Each wireless tablet receives from the teaching computer the educational content display information that is to appear on the screen of the wireless tablet. Management of the educational content by the wireless tablet includes transmitting touch information input by the pupil on the wireless tablet to the teaching computer. Each tablet may access the virtual environment via VNC, via Citrix, or via similar technologies, that enable the screen to be used remotely and that enable input from a mouse to be sent (where a stylus may be considered as being a mouse in certain examples). It is also possible to use specifically-developed software, which may be based on protocols such as RFB, ICA, RDP, or X11, or on proprietary protocols. The teaching computer may thus include a logic server (e.g. a VNC server), and the tablet may include a client (e.g. a VNC client) enabling the tablet to access its virtual environment in the teaching computer. In an example, the wireless tablet may be of limited capacity (essentially receiving information to be displayed and sending touch input for it to be processed by the teaching computer, by using a client of the VNC client type). All of the information input via the tablets can thus be stored on the teaching computer (and in particular on its server, if there is one). The server may include data redundancy mechanisms such as a redundant array of independent disks (RAID) in order to ensure the integrity of the data, or it might have a power supply backed up by an inverter, so that integrity is thus better than that provided by a conventional tablet. The calculation power of such a server may also be considerably greater than the combined power of the tablets of the class and may provide greater user comfort. The tablets may be all identical, i.e. completely interchangeable. At any moment a pupil can thus put down a faulty or discharged tablet and take another tablet, become recognized by the identification circuit of the tablet, and continue working from where the work was left off, given that the work is virtualized in the server.

When the environment of the tablets is virtualized by the teaching computer, and when it is arranged to supervise the execution of one or more multimedia files, for a given wireless tablet, by displaying a copy of the display on that wireless tablet on the screen of the teaching computer, and by displaying on the screen of that wireless tablet information that is input as a function of the display by a teacher using the teaching, the tablets have no need to include a tool for taking control remotely (such as a VNC server, a Citrix server, or any similar system using a protocol such as RDP, ICA, RFB, or X11), but only need to have a client (such as an above-mentioned VNC client). The teaching computer may have a client (e.g. a VNC client) corresponding to the server (e.g. a VNC server) already installed on the teaching computer in order to give a tablet access to its virtual environment. The teaching computer itself determines the content to be displayed on the screens of the tablets (in the context of virtualization), and is thus capable of obtaining the content for the purpose of supervising the tablet without passing via the tablet in question.

In an example, the sending of educational content from the teaching computer to all of the wireless tablets that have identified their respective users as being pupils of the group by means of the identification circuit, which educational content corresponds to the associated multimedia file(s), includes sending the multimedia file(s) to each of the wireless tablets (which file(s) may for example be in HMTL or PDF format, or also in any other suitable format, such as XML, RTF, AVI, MP3, MP4, OGG, etc.). The management of the educational content by each of the wireless tablets includes each of these wireless tablets executing the multimedia file(s) (by means of a web browser in the tablet or by means of any other entity of the tablet that is suitable for processing such files). The teaching computer is arranged to supervise the execution of one or more multimedia files by a given wireless tablet by itself executing the same multimedia file(s) (e.g. using the same web browser or the same entity as that in the tablet) and by obtaining from the wireless tablet a copy of the touch input from the pupil via the wireless tablet (in order to emulate the input and thus reproduce an environment equivalent to that to the tablet). Thus, the teaching computer and the tablet can both display the first page of a PDF document, and when the pupil clicks on a button on that page, the click can not only be taken directly into account by the tablet but also be transmitted in parallel to the teaching computer so that it simulates the click and obtains a display equivalent to that present on the tablet.

In an example, the teaching computer is arranged to supervise the execution of one or more multimedia files, by interrupting the execution of one of the multimedia files on at least one of the wireless tablets. A teacher observing that a pupil solving a problem has set off on the wrong track can thus freeze that pupil's screen and give the pupil help, possibly in writing (directly on the screen of the tablet) so as to avoid disturbing the class with an oral intervention that might be pertinent only for the pupil in question. The teaching computer can be arranged to then allow the teacher to cause the tablet to continue with execution of the multimedia file.

In an example, the educational session creation circuit arranged for creating the subset of multimedia files and the session file is arranged so that the session file also specifies the subset. This is advantageous since it makes it possible during a session (and not only at the stage of preparing the session) to make provision for broadcasting some other multimedia file (e.g. when one or more pupils do not react in the expected manner, or when an exercise in a multimedia file turns out to be too complex), and this can be done without any need to search among all possible multimedia files. In an example, the teaching computer is arranged to supervise the execution of one or more interrupted multimedia files by selecting one of the multimedia files from the subset defined in the session file, and by causing this file to be executed by at least one of the wireless tablets (or by some other entity on behalf of the tablet(s)). The teaching computer may be arranged to make the operation possible merely by dragging and dropping a multimedia file of the subset into the group (for broadcasting to an entire group) or into the tablet (if the teacher is sending it to a particular tablet only).

In an example, an electronic system for providing assistance in teaching includes an interactive whiteboard (IWB) and/or a video projector, the management circuit being arranged to use the interactive whiteboard or the video projector to display the multimedia content that results from executing a multimedia file. For example, when a pupil gives the right answer to an exercise (or on the contrary when a pupil makes a major mistake that is also made by numerous pupils or that needs to be discussed by the entire class), the teacher can project the content of that pupil's tablet on the IWB or the video projector. For this purpose, the tablet may include a VNC server (or an equivalent), or the environment of the tablet may be virtualized in a computer that includes a VNC server (or an equivalent). The IWB (or the video projector) may then be connected to a computer (such as the teaching computer) that has a VNC client (or an equivalent) suitable for displaying the screen of the tablet (or it may itself have its own computer with such a VNC client or an equivalent).

The management circuit may also be arranged to enable a multimedia file to be selected from the subset specified in the session file and to cause this multimedia file to be executed by the teaching computer with the multimedia content resulting from execution of the multimedia file being displayed by the IWB or the video projector. The teacher can thus display the educational content of a multimedia file that has not previously been transmitted to any of the tablets, e.g. a multimedia file including an illustrated answer for an exercise that has just been done, or any other suitable educational content.

In an example, a group of pupils (defined by the class configuration circuit) may include an indicator specifying that the multimedia file(s) associated with the group should be displayed on the IWB (or the video projector) instead of on the tablets (or as well as being displayed on the tablets). The indicator may be stored in association with the group in the session file. Another group may correspond to a set of pupils located in the classroom so that they cannot see the IWB or the screen onto which the video projector is projecting (so that they are not disturbed thereby), with the tablets of the pupils in this other group being arranged to receive educational content that is different from the content displayed on the IWB (or the screen).

In an example, the system has a supervisor circuit arranged to store the touch inputs made on each of the wireless touch tablets which user is identified as being a pupil of the list of pupils.

The supervisor circuit stores the touch inputs in a file associated with that pupil and including the space coordinates of the touch input under consideration (e.g. the abscissa and ordinate values of the point where the screen was touched, or polar coordinates for that point). The file associated with the pupil also includes a time marker specifying the instant at which the touch input was made (e.g. in the form of the time that has elapsed since the beginning of the exercise, which may be expressed in hundredths of a second, for example). The time maker may also rely on a time reference of the supervisor circuit, of the tablet, or of the teaching computer (these three entities may in fact have a time reference in common, e.g. being synchronized with the help of an external unit such as a server connected to an atomic clock). Thus, the time marker may correspond to the exact time (e.g. to within one hundredth of a second) in the time zone within which the entities are located. The touch input may be the result of touches made on the screen with a stylus (or, in another example, direct touches with a finger, even though that is less accurate than a stylus). The touch inputs take place after the tablet has displayed the educational content. They correspond to the pupil interacting with the educational content. The educational content (e.g. in HTML format or in a proprietary format) may be displayed with software installed on the tablet (e.g. a web browser or dedicated software, possibly proprietary software) or it may be contained in an executable file executed by the tablet.

Storing the space coordinates and the time markers is advantageous in particular in that it makes it possible to implement a playback mechanism that is independent of the means used for displaying the educational content. Thus, there is no need to be in a position to determine the meaning of the pupil's input (e.g. there is no need to determine what the pupil is writing, or to determine that the pupil clicked on a particular displayed element from a list of elements, or to determine that the pupil is performing any specific task). It suffices to play back the educational content while simulating the interactions of the pupil (because the pupil's inputs have been stored, there being no need for the system to understand them). Thus, if a new type of educational content is developed and requires new specific software, there is no need to modify the method of storing the space and time coordinates of each input, which system continues to be operational. It suffices to install the new specific software, thereby minimizing problems of integration.

It is possible to store other parameters, such as the force with which the pupil presses on the stylus (or a finger), or the angle of inclination of the stylus, provided the technology of the touch screen and the stylus make that possible. The recording of each input may include additional information, such as a possible change of palette (the “color” of the stylus, i.e. the color that is displayed while the pupil is drawing with the stylus). The additional information may be more particularly pertinent when it does not result directly or indirectly from the pupil's touch input, and when it cannot be determined as a function of that input and of the displayed educational content. Thus, a change in the thickness of the trace drawn, initiated by the pupil clicking on an icon provided for this purpose, may be determined a posteriori solely on the basis of the pupil's input and of the educational content. For example, at the moment of the appropriate input, the displayed content may include an icon for changing line thickness at the location where the pupil has clicked; Nevertheless, certain parameters may be external parameters. For example, the teaching computer may be arranged to intervene on the pupils' tablets. It may in particular intervene in order to change a thickness parameter of the stylus on the screen. Dots may be larger or smaller and lines drawn on the screen may be thicker or thinner, depending on the thickness parameter. If the teacher finds that a pupil with poor eyesight is writing with a line that is too fine, the teacher can thus change the thickness of the lines drawn without moving (from the teaching computer) and even without involving the pupil. By way of example, the teaching computer may also be arranged to change the current color (from among the colors in a suggested palette) used by the pupil without the pupil intervening and without interrupting the pupil's work. The teaching computer may also be arranged to enable such a modification to be made globally (for a predetermined group of pupils or for the entire class). Thus, instead of saying “take your blue pen” and then waiting (possibly for a long time with young children) for all of the pupils to configure their styluses (e.g. by clicking on a blue icon), the teacher can merely configure all of the tablets from the teaching computer so that the touch inputs from the styluses all give rise to blue marks. Under such circumstances, any subsequent touch input carried out by each of the pupils may cause the change of palette or of line thickness (or of any other parameter that has been performed on the tablet from the teaching computer to be stored in the corresponding file associated with each of the pupils). While also storing the coordinates of the input and a time marker (a time stamp for each input), it is also possible to store parameters that can be determined but that are lengthy and/or complex to determine. Thus, instead of performing lengthy calculations on the basis of the transmitted educational content and of the touch inputs in order to determine these parameters, the parameters are stored directly. However it is generally appropriate to decide on including such parameters in the files only after taking into consideration the size of the files and the bandwidth requirements they generate (when such files are exchanged). It is often more appropriate to optimize file size and bandwidth by ignoring such superfluous parameters, even though that can slow down playback processing of the files. Nevertheless, in certain circumstances, for file playback to take place at the same time scale as used while storing input, it may be found that the calculation file of the teaching computer is not sufficient. Instead of requiring a more powerful teaching computer, one option might then consist in transmitting the precalculated parameters so as to avoid the need to have them calculated by the teaching computer.

In an example, the touch inputs of a pupil are obtained by sampling at a frequency lying in the range 5 hertz (Hz) to 100 Hz. Thus, when the stylus (or any other element such as a finger) is not in contact with the screen, no input is stored. However when the stylus (or any other object) is in continuous contact with the screen (e.g. while the pupil is drawing and holding the stylus in a pressed position), up to 100 inputs may be obtained per second (for a sampling frequency of 100 Hz). In an example, a high sampling frequency (such as 100 Hz) is used in order to be able to measure fast movements of the pupil with very good resolution. In an example, decimation or interpolation is performed on the basis of the inputs that are obtained before they are stored. Thus, if the inputs represent a movement that is regular, the supervisor circuit may perform interpolation (e.g. a polynomial interpolation). It can thus select some minimum number of inputs for storing from among all of the inputs obtained given the sampling frequency, e.g. by using the least squares method (or a similar method) to ensure that the difference between the curve interpolated on the basis of these minimum inputs and the curve corresponding to all of the inputs actually obtained is as small as possible (difference smaller than a predetermined threshold). This avoids storing a very large quantity of inputs (such as 700 inputs in a specific example). If made possible by the regularity of the touch inputs (and in particular if the inputs correspond to writing very slowly or very regularly, such as drawing a straight line), the supervisor circuit stores only a small number of inputs (such as 12 inputs in a specific example). These stored inputs may optionally be associated with interpolation information making it possible (during playback) to determine in optimum manner an approximation for all of the inputs actually obtained (but most of which were not stored) on the basis of the few inputs actually stored (e.g. 12 inputs in the above example). Depending on the predetermined threshold, an approximation by interpolation may be indistinguishable to the human eye from the genuine input. This has the potential of very greatly reducing the volume of inputs that are stored, and thus the size of the file.

The supervisor circuit is arranged, on request from the teaching computer, to play back the educational content transmitted to the touch tablet used by a given pupil in the list of pupils, simultaneously together with the result of the touch inputs applied to the same touch tablet. This playback may take place on the teaching computer, thereby emulating the tablet. It may take place after the class, while the teacher is evaluating the work of the pupils or is seeking to understand the difficulties of a pupil. The teacher thus sees what the pupil saw when confronted with the educational content, and the teacher also sees how the pupil interacted with that content, exactly as though the pupil's tablet were being filmed while the pupil was doing the exercise.

The supervisor circuit may form part of the teaching computer or it may be a distinct entity (such as a separate server). The supervisor circuit may be a digital signal processor (DSP). It may also be a conventional processor (it may even be a processor that already exists in the teaching computer, such as its main processor), associated with memory storing a program suitable for performing the supervision. It may also be a dedicated electronic circuit, such as an ASIC or an FPGA, or an electronic circuit made entirely to measure, or a dedicated microcontroller. It may also be a combination of a component of the tablet and a component of the teaching computer or of a distinct server. In another example, the supervisor circuit may have components in each of the tablets, these components being in charge of supervising the tablets in which they are integrated, and providing a supervision interface with the teaching computer (it may for example be a web interface accessible by using a web browser of the teaching computer).

The educational content is interactive content. In particular, it may include exercises to which the pupil is to give answers, e.g. by clicking on the correct answers from among all of the answers suggested, or by coloring a drawing, or by copying lines of writing in accordance with instructions and with the stylus. The supervisor circuit may be arranged to transmit to the teaching computer the educational content that was previously transmitted to the tablet, in the form of an executable file. The educational content may be content executed by the tablet itself, e.g. in the form of an HTML file containing JavaScript code that is processed by a web browser of the tablet, or of a PDF file containing JavaScript code. The same content (rather than screen copies of the content) may be retransmitted to the teaching computer.

The content may also be stored within a file that is directly executable by the tablet. The term “directly” means that there is no need to open the file using suitable software in order to execute it, but on the contrary that the file can be executed by the processor of the tablet without calling on any specific software, with the file, while it is being executed and where appropriate (and at its discretion), potentially calling on an operating system of the tablet or on specific pieces of software. In order to trigger execution of the file, it is nevertheless possible to pass via a graphical interface of dedicated software or of an operating system of the tablet. By way of example, the multimedia file may be a file in the “portable executable” (PE) format, usually having an extension .EXE (where the “extension” of a file specifies the characters following the last dot included in the file name), and appropriate for a tablet having a Microsoft Windows CE operating system. In particular, it may also be a file in the “executable and linkable format” (ELF) having a name that often does not have an extension (the name of a file often does not include a dot) and suitable for a tablet using a Linux operating system, or any other suitable format, depending on the type of tablet. More generally, the content may be stored within any multimedia file in accordance with the subject matter of claim 1.

The teaching computer can then execute this content and simulate the actions of the pupil on the basis of the stored inputs. Thus, software in the teaching computer can open a file (HTML, PDF, etc.) containing the educational content (that may be referred to as the “content file” and that may be a multimedia file in accordance with claim 1), that was originally opened by the tablet using a browser or any software suitable for opening such a content file (the content file may for example be a simple text file having no executable code, that the pupil views on the tablet using a text editor and that the pupil has added to in compliance with instructions from the teacher and by using the text editor, e.g. by using a virtual keyboard displayed on the screen, and clicking on selected letters). In another example, the teaching computer may execute the content file directly if it is a directly executable file. The teaching computer may then transmit events to the browser (or to other software or to program resulting from executing the content file when the content file is a directly executable file), which events simulate the touch inputs, but are actually recreated artificially from the file associated with the pupil in question.

The content file and the file associated with the pupil may be two distinct files. The file associated with the pupil may be duplicated (e.g. on the tablet and/or on other entities such as the teaching computer) and it may be updated in parallel (with each instance of this file being updated, e.g. in synchronized manner, in real time, or on the contrary once in a while, e.g. at the end of a session). In another example, the file associated with the pupil is in fact a content file that is modified by adding the pupil's inputs (the inputs being represented at least by their space and time coordinates). Under such circumstances, a content file may for example be present initially in the teaching computer (or elsewhere) and then transmitted to the tablet for display (the content file is then duplicated on two distinct computers constituted for example by the tablet and by the teaching computer), and then updated progressively as it receives inputs from the pupil (the system may update both versions of the content file, or only one of them).

The teacher can thus observer how the pupil in question grasps the exercise. In particular, the teacher assesses not only the final result (e.g. the writing of letters and digits) but also the method used for achieving this result. By way of example, the teacher may observe that the pupil is not forming letters and digits (or perhaps only some of them) in the order requested by the teacher. For example, the teacher may observe that when the pupil is forming the digit 8, the pupil begins by drawing a large circle low down and in then a small circle on top, which is not in compliance with the method that is being taught, even though the final result might be satisfactory. By way of example, the teacher may also understand why a pupil is slow or may identify aspects of an exercise where the pupil has spent too much time or has changed an initial answer many times, before deciding on a final answer (whether right or wrong).

In an example, the supervisor circuit is also arranged to supervise a tablet in real time (as well as or as an alternative to storing the pupil's lesson for deferred viewing by the teacher). The supervisor circuit may also transmit the information that is input to the teaching computer. Thus, the teacher can monitor at all times what a pupil is doing from the teaching computer without having to go to the pupil's table.

In an example, the supervisor circuit includes a converter for transforming the file associated with a given pupil (and in combination with the educational content under consideration) into a video in an ordinary recording format such as an MPEG4, DIVX, H264, WMV, or RealVideo format. The teaching computer can thus be used to send parents the work of their children without the parents needing to have any particular software or system suitable for decoding the file associated with a pupil. Clearly a video recording, although easier for the parents of pupils to use, is liable to loose quality associated with video compression, and it occupies a large amount of space compared with storage. Such videos may be recorded on a file server integrated in the teaching computer (or hardware separate from the hardware of the teaching computer that includes the user interface used by the teacher, for example the teacher may have a laptop computer and the file server may be a physical server that is distinct and connected to the laptop computer, so that in combination, together they form the “teaching computer”).

In an example, the supervisor circuit is arranged, on storing too small a number of pertinent touch inputs for a given wireless touch tablet over a period of time longer than a predetermined threshold, to notify this event of insufficient touch inputs to the teaching computer.

It is possible to provide a plurality of thresholds, each suitable for triggering an event notification, depending on the number of touch inputs during a duration associated with each threshold.

In an example, all touch inputs are considered as being pertinent.

In an example, the supervisor circuit notifies an insufficient input event in the event of no interaction at all between the pupil and the tablet (no touch input) when this lack of input exceeds a predetermined duration (e.g. two minutes).

In an example, the supervisor circuit notifies an insufficient input event when the number of touch inputs (of any kind, i.e. all touch inputs are considered a priori as being pertinent) made by the pupil on the tablet is lower than a given value and when this number remains lower than the given value for a duration that exceeds a predetermined duration (e.g. less than three touch inputs during five minutes).

In another example, the supervisor circuit is arranged to identify certain touch inputs as being not pertinent (not to be taken into account when deciding on notifying an insufficient input event). For example, inputs on non-active screen zones may be considered as being not pertinent. A non-active zone is a zone with which no action is associated (other than detecting the input and observing that no action is associated therewith), this touch input then being equivalent to no input from the point of the result it produces. Possibly, inputs that seek to make adjustments (adjusting the brightness of the tablet, adjusting sound volume if the tablet plays sound, possibly via a headset, etc.) may also be considered as non-pertinent inputs. For example, certain inputs seek to cause a text to scroll, to zoom, or to change the orientation of an image, and these inputs may be considered as being non-pertinent inputs. Each educational content may be associated with a particular set of types of input that are considered as being non-pertinent in the context of that educational content.

Thus, in an example, the supervisor circuit notifies a lack of pertinent inputs from the pupil (i.e. the only inputs that might have been identified are excluded as being non-pertinent) when this lack of input exceeds a predetermined duration (e.g. five minutes).

In another example, the supervisor circuit notifies the fact that the number of pertinent inputs from the pupil (i.e. ignoring inputs that are considered as being non-pertinent) during a predetermined input is less than a predetermined value (e.g. less than fifteen pertinent touch inputs in ten minutes). By way of example, this predetermined value may correspond to the mean number of inputs needed to do an average exercise during a period of time, possibly minus a certain percentage. This possible reduction serves to avoid notifying pupils who are a little slow, and who are possibly already known, instead concentrating on those who are really not working enough, in order to remedy this lack of work. This example applies particularly well to exercises in which the number of pupil interactions with the tablet (number of touch inputs) is supposed to be distributed in substantially linear manner (e.g. for a series of short questions of uniform complexity).

Thus, the teacher can become aware that such and such a pupil is not working or is working much too slowly even though that might have escaped the teacher's attention if the teacher is preoccupied with other pupils (e.g. disorderly pupils).

A notification by the supervisor circuit may cause the screen of the teaching computer to display a list of active tablets (if that list is not already displayed by default). Each active tablet may be associated with an icon. For example a green icon communicates that the pupil is interacting regularly with the tablet. A yellow icon may indicate that the pupil has not input any information (or any pertinent information, or much too little information or much too little pertinent information, depending on the selected configuration) for a length of time that is longer than a determined threshold (e.g. one minute). A red icon may indicate that some other threshold (e.g. five minutes) has been exceeded during which the pupil has not input any information (or any pertinent information, or much too little information or much too little pertinent information, depending on the configuration selected). The supervisor circuit may send a message to the teaching computer (or may trigger a software interrupt, or use any other appropriate method of notification) in order to inform it of any threshold being crossed by any of the tablets, and update the display. It may cause a particular sound to be issued drawing the attention of the teacher and of the pupil each time a threshold is crossed. This sound may in particular be issued by the tablet of the pupil in question, on the teaching computer, or on both together. This option may be deactivated, e.g. in order to avoid stigmatizing a pupil.

In order to make the display of tablets on the teaching computer more user-friendly, the following provisions may be applied. The tablets may have accelerometers in order to determine their positions in the classroom. At least two accelerometers are needed (one for one horizontal axis and the other for another horizontal axis). It may be advantageous also to have an accelerometer for a vertical axis in order also to measure the height of the tablet (but this is not essential in general). Knowing the height can assist in locating a tablet that has temporarily been mislaid (e.g. stored by a person other than the teacher, e.g. a pupil or a classroom cleaner, or by the teacher but not in the right place, for example). It is possible to use a greater number of accelerometers, and it is thus possible to use six accelerometers in order to know its position with more accuracy. It is also possible to provide gyros in order to know the orientation of each tablet, but (in general) this is not essential in this context.

The supervisor circuit can thus display a list of pupils (sorted alphabetically or using some other criterion or not sorted), and it can also display a plan of the classroom corresponding to the real positions of the pupils in the classroom (as communicated by the accelerometers of their tablets), which can be very practical for the teacher. This can enable the teacher to avoid creating a plan of classroom manually in the system. In addition, this represents the real situation, e.g. unexpected changes of position by certain pupils, e.g. in order to separate two pupils who argue or chatter too much. This also makes it possible to automatically take account of the creation of subgroups (with differentiated instruction, or subgroups defined arbitrarily in the context of a particular exercise). It may also happen that the children are sitting on the ground (e.g. in a library corner of the classroom) in an arrangement that cannot be predicted in advance. The system can also be used during music or plastic arts classes (or classes in the school library for familiarization with literature), or more generally courses that are being run not by the usual teacher of the class but by a specialist teacher (or a librarian, etc.), who may not know all of the pupils and in particular may not know the shyest pupils (especially when in charge of a very large number of pupils). In addition, such courses may take place in an environment different from the usual classroom (a music room, a plastic arts room, etc.) that may be fitted with its own electronic system for teaching assistance. The system may also be used by a replacement teacher who does not know the pupils in the class as well as the absent teacher does. Thus, obtaining a plan of the classroom automatically and dynamically can be extremely advantageous, with the information displayed on the teaching computer being usable immediately.

In an example, the docking station may be arranged to reinitialize accelerometers of the tablets (and possibly reinitialize their gyros if they have them). The angle measurement given by a gyros and the position measurement given by an accelerometer are both obtained by integration, which means that errors accumulate and that inaccuracy in the measurements given (estimated angle or position along a given axis) increase with time. Gyros and accelerometers are initialized with their current attitude and position, and then they update their positions and attitudes by double integration of the accelerations they measure. The attitude (or orientation) designate the directions in three dimensions of three reference axes of an object relative to a rectangular frame of reference. This updating diverges over a certain amount of time (because small errors accumulate) and it can be necessary to give the accelerometers (or the gyros) their true positions (or attitudes). In an example, it is assumed to a first approximation that when the tablets are in their docking station, they are situated at the same position and attitude, and all of the accelerometers (and gyros if they have them) are reinitialized to a single unique position (e.g. position (0,0,0) and a single unique attitude (e.g. 0,0,0)). This means that the inaccuracy in the measurement of the positions of the tablets is of an order of magnitude similar to the maximum distance between the two furthest-apart tablet docking ports (within the docking station), which is generally a distance that may be of the order of one meter. When the tablets include gyros, and when the gyros are reinitialized in the manner specified, it is necessary for the docking station to be arranged in such a manner that the attitudes of the tablets that are inserted therein are substantially identical (any error giving rise to inaccuracy in determining the attitudes of the tablets).

In an example, reinitializing each accelerometer in each tablet takes account of the port in which that tablet is inserted, thereby eliminating the inaccuracy due to the approximation set out in the preceding paragraph. When a tablet is inserted in a port and is being charged, it is assumed that the position of that port is stationary relative to the docking station. The docking station is arranged to know the position and the attitude of each tablet charging in a given port (e.g. identified by a number of the port or by some other identifier) relative to the docking station. These positions and attitudes are defined when the docking station is designed and they are independent of the position and the attitude of the docking station itself.

Thus, when the position and the attitude of a tablet being charged by a port are known, it is immediately possible to deduce the position and the attitude of the tablet charging in the other ports. The relative positions of the tablets constitute information that is sufficient (their absolute positions might potentially be useful, but in general they are not essential). Thus, the fact of not necessarily knowing the position and the attitude of the docking station itself is not a problem in this example. The position of a tablet being charged by a port is entirely determined by the abscissa value, ordinate value, and height of a reference point of the tablet and the three-dimensional orientation of the tablet is fully determined by the yaw, roll, and pitching axes of the tablet. In an example, it is only the abscissa and ordinate values of the tablet that matter. The various ports of the docking station may be spaced apart vertically and in a horizontal plane. For example, the docking station may have thirty-two stationary ports all having the same attitude and distributed in four columns, with two consecutive columns being horizontally spaced apart from each other by 25 centimeters (cm), two consecutive ports in a given column being vertically spaced apart by 12 cm. This is equivalent to saying that the docking station has eight rows of four ports each, that are vertically spaced apart from one another by 12 cm. Thus, reinitializing the accelerometers of the tablets may include setting the current abscissa values of the accelerometers by setting them to zero, setting the current ordinate values of the accelerometers by setting the ordinate values of tablets in the first column to zero, setting the current ordinate values of the accelerometers by specifying that the ordinate values of the tablets in the second column are 25 cm, setting the current ordinate values of the accelerometers by specifying that the ordinate values of the tablets in the third column are 50 cm, and setting the current ordinate values of the accelerometers by specifying that the ordinate values of the tablets in the fourth column are 75 cm. If the tablets are also identified in height, then the docking station can reinitialize accelerometers of the thirty-two tablets in the manner specified above, by also setting the current heights of the accelerometers by giving the tablets in the first row a height of zero, the tablets in the second row a height of 12 cm, and the tablets in row number n, where n lies in the range 3 to 8, as being equal to (n−1)□12 cm.

It is thus possible to represent all of the tablets on the screen in a frame of reference associated with the docking station, and to allow the teacher to apply any desired rotation to the display if the tablets are not oriented in the direction that seems the most intuitive. In an example, the teaching computer includes a teacher's laptop computer that may itself be charged by the docking station and that may include accelerometers (and optionally also gyros). This laptop computer may be displayed on the plan of the classroom in a manner that differs from the display of the tablets (e.g. a different color and a larger size), thereby assisting the teacher in immediately identifying the teacher's own position in the plan of the classroom.

In an example, the tablets include gyros, e.g. a respective gyro on each of three rotation axes. When the tablets are in the docking station, and when all of the ports have the same attitude with pitching and roll angles of zero in a frame of reference in which the vertical axis coincides with the vertical direction of the classroom, it is possible to reinitialize all three gyros (as well as the accelerometers) in each tablet by setting the angles delivered by each of the three gyros to zero. In contrast, if the ports slope downwards so as to enable the tablets to slide towards a stable position at the bottom of the port under gravity (in order to be charged), it is possible to set the value of the pitching angles to the value of this angle of inclination of the port (which is set by construction of the docking station), while leaving the roll and yaw angles at zero.

In another example, the docking station is organized differently, but the position and the attitude of each of the tablets inserted therein are stationary relative to the position and the attitude of the docking station, as above. For example, the docking station may have ports arranged along superposed circular arcs. It is possible for each port to store the six parameters constituted by the yaw, roll, and pitching angles and the three coordinates (possibly corresponding to the coordinates of the center of gravity of the tablet) for a tablet loaded into the port, in the frame of reference of the docking station. The accelerometers and the gyros of each of the tablets are each reinitialized by setting their values as being equal to the six parameters associated with the port in which the tablet is loaded (i.e. the three coordinates and the three angles).

In an example, the docking station is movable (e.g. mounted on casters). Under such circumstances, and without additional provisions (such as those described below), the teacher needs to be informed that all of the tablets must be stored simultaneously in the station for the purposes of reinitializing their accelerometers and/or gyros (and possibly for storage and/or for recharging their batteries), or at least that the docking station must not be moved until the accelerometers and the gyros of all of the tablets have been reinitialized (unless they are reinitialized again when the docking station is in its new position). In practice, it can be assumed that reinitialization is performed at least once per day (at the end of the day, the tablets are typically all stored and being charged). Reinitialization may be automatic. It is advantageous for it to be performed at the time the tablet is extracted from the docking station (or at least as late as possible before being taken therefrom), so as to be as up to date as possible (with minimized drift). For this purpose, as soon as a tablet has been inserted in the docking station, reinitialization may take place continuously so long as the tablet has not been extracted. In another example, reinitialization may be performed once every minute (or at some other rate) once the tablet has been inserted in the docking station and until it is extracted therefrom. Reinitialization may also be manual, on an instruction from the teacher using the teaching computer.

In another example, the docking station may itself be provided with a set of accelerometers and gyros enabling it to know its own position. It is useful for the docking station to have at least two accelerometers and at least one gyro. An accelerometer along the vertical axis is generally superfluous since the docking station will not normally change its altitude (will not normally be raised or lowered) while it is in a classroom (unless the classroom includes a lower portion or a higher portion accessible to the docking station). In contrast, it is possible to use more than two accelerometers in the horizontal plane in order to improve measurement quality, e.g. the station may have four accelerometers. It is also possible to provide redundant accelerometers (e.g. each of the four accelerometers may be duplicated) in order to provide a high degree of reliability (e.g. in the event of an accelerometer failing). In this example, the station includes at least one gyro on the vertical axis. Gyros on the other two axes representing pitching and roll are not generally pertinent since the floors in classrooms are generally flat and any pitching or rolling can generally be excluded. Nevertheless, certain inertial units may be provided by default with gyros on all three possible axes and it may be appropriate to use them even when measurements from two gyroscopes are not necessarily very pertinent. In a possible example, it is possible to use a plurality of gyros for redundancy purposes and/or in order to improve the quality with which the angle giving the orientation of the docking station is measured relative to a vertical axis (yaw angle). It is advantageous to measure this angle since the relative positions of the tablets are affected not only by the frame of reference of the docking station moving in translation, but also by its frame of reference turning through a yaw angle.

Instead of (or as well as) reinitializing the accelerometers (and the gyroscopes if any) of the tablets, such a docking station may synchronize them. That is say instead of copying the six constant parameters associated with each port into the respective registers of the three accelerometers and the three gyros of the tablet inserted in the port, the station uses these six parameters, but corrects them to take account of the position and the attitude of the station. It thus performs a change of frame of reference, going from the frame of reference of the station to the frame of reference of the classroom. As mentioned above, it is possible to use fewer than six parameters, e.g. it is possible to use only two parameters (abscissa and ordinate values) in the tablet and to update them while using only three parameters of the docking station (its abscissa and ordinate values and its yaw angle). The station may simultaneously synchronize and reinitialize the accelerometers and the gyros of each tablet, by providing two registers for each accelerometer and for each gyro of each tablet. One series of registers thus makes it possible for the tablet to know its position and attitude in a frame of reference of the docking station, and another series enables it to know them in a frame of reference of the classroom.

By means of these provisions, the teacher can put tablets into the docking station for charging in non-simultaneous manner and regularly move the docking station without that interfering with the mechanism for synchronizing the accelerometers and gyros of the tablets, since any movement of the docking station is taken into account as a result of changing the frame of reference. Nevertheless, it is appropriate to ask teachers not to extract a tablet from the docking station while it is moving, or by default to synchronize the tablets continuously or with a refresh interval that is very short. The interval of one minute proposed above in one example for reinitialization is too long to be transposed to synchronization under such circumstances, since the docking station can be moved substantially in only a few seconds.

In principle, the drift of the accelerometers and of the gyro(s) in the docking station matters little, insofar as the drift is sufficiently slow to be of little significance over a period of time needed for synchronizing all of the tablets. For example, it is possible to assume that the tablets are used shortly after being extracted from the docking station, and that in any event they are stored and recharged and thus synchronized at least once per day. Drift over the duration of a school day (i.e. about eight hours, generally from 8:30 AM to 4:30 PM) can be considered to be of little importance, and would be manifest in the event of one tablet being extracted from the docking station at 8:30 AM, and another at 4:29 PM, with both of them being used during the last minute of the school day. Under such circumstances, the relative positions of those two tablets (as indicated by their respective accelerometers and gyros) would be distorted by the sum of the drift between 8:30 AM and 4:29 PM of the accelerometers and the gyros of the tablet extracted at 8:30 AM and of the accelerometers and gyros of the docking station.

The above example in which the docking station performs synchronization continuously or at very short intervals (while the tablets are in the station) serves to manage problems associated with drift without the teacher even being aware that such problems exist. The teacher can thus move the docking station freely at any moment, and can charge the tablets in non-simultaneous manner, it being understood that the running time of each tablet in any event requires it to be recharged periodically, thus enabling it to be resynchronized periodically.

Nevertheless, a system for reinitializing the accelerometers and the gyros of the docking station could also be arranged to avoid drift becoming so great as to lead to undesirable side effects, for example. By way of example, one accelerometer may drift faster than another, and after a certain length of time may give a value that is capable of overflowing the size of a register, or rounding errors giving rise to inaccuracies on the estimated positions. For example, if one accelerometer initialized to zero has drifted by ten kilometers after a few years, the measurements delivered by that accelerometer will lie in a range of several meters around ten kilometers. In one possible use, the classroom measures fifteen meters and it is desired to obtain measurements that are accurate to within about ten centimeters. The accelerometer would than return a position lying in the range approximately 10,000.0 meters (m) to 10,015.0 m, i.e. the measurement accuracy of interest (accuracy to within 10 cm) represents about one hundred thousandth of the measurement returned. If it is desirable to calculate a distance, it may be necessary to square the measurement, and the accuracy of measurement of interest then represents one ten-billionth of the square of the measurement returned, which can give rise to rounding errors having a large effect on accuracy. In order to remedy that risk, it is possible to work on registers of very large size providing immunity against rounding errors, but that may turn out to be very constraining and to reduce performance, while complicating portability of the software and updating of the software (in a software implementation). In another example, as soon as the docking station detects that all of the tablets are inserted simultaneously, it may reinitialize its own accelerometers and gyros to zero, and reinitialize the accelerometers and the gyros, if any, of the tablets by using the six values associated with each port (or using any other one of the above-described reinitialization methods). This situation (simultaneous presence of all of the tablets) is not necessarily very frequent, since a tablet can often be forgotten in a locker or under a table. Nevertheless, it can be assumed that it happens at least once per month, approximately, which may be sufficient. Otherwise, on observing a large amount of drift on at least one of its own accelerometers, or in the event of no reinitialization being performed for a duration longer than a given threshold (e.g. one month or any suitable value), the docking station may send a message to the teaching computer. A large amount of drift may be considered as being observed when the position given by one accelerometer gives a value that is clearly outside the classroom, e.g. a value of more than one hundred meters when the accelerometer was initialized to zero on being installed in the classroom. The message sent to the teaching computer may display a window requesting the teacher as soon as possible (e.g. after the class) to put all of the tablets into the docking station in order to proceed with complete reinitialization of the accelerometers and gyros of the station and the accelerometers and gyros of the tablets. In another example, instead of sending a message requesting the teacher to put all of the tablets in the docking station, the station may wait until the number of tablets simultaneously present in the station exceeds a certain threshold (e.g. 85% of the tablets). This generally occurs sufficiently often (generally once per day, whenever the tablets are stored after class). The station then proceeds to reinitialize the accelerometers and gyros of all of the tablets while at the same time reinitializing the accelerometers and gyros of the docking station. This operation can have the effect of completely desynchronizing those tablets that were not in the docking station (even though this is not necessarily the case after a period of one month or some other period that has triggered the operation, since it is theoretically possible that there has not been any significant drift, even if that is not very probable). This desynchronization relates to no more than 15% of the tablets if the threshold is set at 85%. These desynchronized tablets may all of a sudden appear to be located virtually at a distance from the other tablets that is absurd (according to the indications from their own accelerometers and gyros). In an example, the docking station marks these tablets as being tablets that are desynchronized, and notifies the teaching computer. In an example, the docking station is managed by the teaching computer, since they are both the same computer (in which case no notification is necessary). In a variant, the teaching computer has a computer for the teacher and a physical server, and it is the physical server that provides complete management of the docking station. Whatever the situation, the teaching computer can then group together the desynchronized tablets (or potentially desynchronized tablets). This group of tablets, or at least the subgroup of those tablets that are being used by pupils in the class, may be displayed on the screen. This subgroup can be displayed in arbitrary order, or in alphabetical order of the names of the pupils concerned. The desynchronized tablets may also be displayed separately depending on their relative positions. Their relative positions may be determined on the basis of desynchronized (or potentially desynchronized) position information from their respective accelerometers and gyros. They are desynchronized or potentially desynchronized only relative to the tablets that have been reinitialized, however relative to one another they should in theory still be substantially synchronized. The teaching computer can display an indication on the screen to inform the teacher that the positions of these few tablets are uncertain and that it is desirable for them to be resynchronized by being inserted for at least a few seconds in the docking station so that they can be displayed together with the others. In any event they are to be resynchronized as soon as their batteries run down (since they then need to be reinserted in the docking station in order to be charged) or as soon as they are stored in the docking station (e.g. a the end of the day after the courses, independently of any need to charge batteries).

In an example, the electronic system for providing assistance in teaching is arranged so that the educational content includes (at least) a portion associated with a tag specifying an expected frequency of touch interaction. The predetermined threshold from which a warning is sent to the teaching computer in the event of inaction is then a function of the tag.

Thus, certain exercises can require more thought than input, e.g. reading a long text, prior to answering questions, whereas other exercises may be exercises involving an immediate reaction, as with mental calculation exercises. An educational content may correspond to a session during which the level of interactivity with the pupil fluctuates. Thus, a first portion may be associated with a first expected frequency of interaction, a second portion with a second expected frequency of interaction, and it is thus possible to provide as many portions as necessary. For a mental calculation exercise, it is possible that the expected frequency of interaction to be of the order of 0.33 Hz, i.e. for the pupil to be expected to reply to one question every three seconds on average (clearly other values are possible, in particular depending on the age of the pupils). Nevertheless, the fact that a tablet remains inactive for three seconds is not necessarily sufficient to trigger the sending of a warning. A first threshold (e.g. corresponding to displaying a yellow icon) may for example be set at a first duration, e.g. one minute, during which the mean interaction frequency remains X times lower (e.g. five times lower) than the expected frequency. A second threshold (e.g. corresponding to a red icon) may for example be set at a second duration (e.g. five minutes) during which the mean frequency of interaction remains Y times lower (e.g. likewise five times lower, or possibly more, e.g. ten times lower) than the expected frequency.

All of these thresholds may be set by default and may be adjustable by the teacher with the teaching computer.

In an example, each of the tablets of the system includes an asymmetrical element.

Given this asymmetrical element, the tablet can be more or less ergonomic depending on its orientation relative to the user (and thus on the position of its asymmetrical element), and this can also vary depending on whether the user is right- or left-handed. In an example, the asymmetrical element is a physical element of the tablet, thus constituting an intrinsic characteristic of the tablet (as contrasted with an element displayed on the screen, which depends on the display instructions that the tablet has received).

The asymmetrical element under consideration may be situated on a surface at the periphery outside the screen (above, below, to the right or to the left of the screen) and on the same side (i.e. the same face of the tablet) as the screen. In an example, the asymmetrical element is an element that is fixed relative to the tablet. An asymmetrical element is considered as being fixed if it is fastened at a particular location of the tablet and can be fastened at other locations of the tablet only by a person other than a young child (for example it may be necessary to use a screwdriver). In an example, the asymmetrical element may be movable within set limits (e.g. a trackball or a switch), but may be considered as being fixed if its ability to move remains confined to a zone of the tablet that is small (dimension of the same order as the dimension of the asymmetrical element).

The asymmetrical element may be a webcam, a microphone, a loudspeaker (even though there may equally well be two loudspeakers possibly arranged symmetrically to each other relative to the screen so as to produce stereophonic sound), a trackball, a touchpad, a keyboard, one or more buttons, etc. In an example, the screen of the tablet is a touch screen. The asymmetrical element may be a stylus support (where a stylus is used for inputting information via the touch screen of the tablet).

The tablet may have a plurality of asymmetrical elements (e.g. both a stylus support and a webcam). Under such circumstances, in an example, the teaching computer may be configured to define one asymmetrical element as being a priority element (the element that needs to be taken into account when defining the orientation of the tablet). It can happen that depending on the age of the pupils or on the profile of the class (more or less unruly, etc.), or indeed on the preferences of the teacher, that a different asymmetrical element is considered to be more important than the others in the determining the orientation of the tablet (for example, it may be that the webcam is not used by children under six years of age, or merely that the teacher does not envisage using it, and that as a result the fact that the field of view of the webcam might be obstructed is of no consequence for a given class). This selection may be made with a graphical interface. In an example, selecting an asymmetrical element is replaced by selecting an orientation that is preferred for a given configuration (where the orientation is implicitly due to the asymmetrical element that is fixed relative to the tablet, or to a plurality of asymmetrical elements, without it being necessary to identify the asymmetrical element(s)).

The teaching computer of the system (storing a list of pupils) stores for each pupil in the list a handedness parameter that may take two values, one indicating that the pupil is right-handed and the other that the pupil is left-handed. In an example, this handedness parameter is defined by a third party (e.g. by a teacher), i.e. by a person other than the pupil (since this operation might be too complex for the pupil).

The handedness parameter may take on more than two values, for example it may use a particular value to indicate that a pupil is fully ambidextrous, or another particular value to indicate that the pupil's handedness cannot be determined, or another value to indicate that the pupil's handedness is not known (whether or not it can be determined), where this may be the default value.

The system includes a display circuit arranged to display an educational content on the screen of one of the tablets in a first orientation if the value of the handedness parameter corresponding to the current user of the tablet, as determined by the user identification circuit of the tablet, is a first of the two values for the handedness parameter, and a second orientation if the value of the parameter is the second of the two values for the handedness parameter.

The display of an educational content can thus be oriented differently depending on whether the pupil using the tablet on which the educational content is being displayed has been identified as being a right-handed pupil or a left-handed pupil.

If the pupil using the tablet is not identified by the user identification circuit of the tablet, or is identified neither as a right-handed pupil nor as a left-handed pupil, it is possible to select a default orientation, e.g. the orientation that would be selected for a right-handed pupil (likely the most relevant orientation). By way of example, this circumstance can arise if the pupil is ambidextrous or if the pupil's handedness is not known, or is not stored, as can happen when a new pupil joins the class during the school year or is sent to the class for the first time temporarily from another class.

The display circuit may be a processor (it may even be a processor that already exists in the tablet, such as its main processor), in association with a memory storing a program adapted to performing the method. It may also be a graphics processor, a dedicated electronic circuit such as an ASIC or an FPGA, or an electronic circuit made entirely to measure, or a dedicated microcontroller.

The first (as well as the second) orientation is defined by an arbitrary angle of rotation (lying in the range 0° to 359.9°) for rotating the educational content before displaying it on the screen.

These first and second orientations may thus each be represented by an angle in the range 0° to 359.9° (clearly it could be expressed in other units for measuring angle) between a reference vector of the tablet screen (which may be selected arbitrarily, once and forever, i.e. a vector that is fixed relative to the screen, which itself is generally fixed relative to the tablet, unless the screen is movable relative to the tablet) and a content reference vector (which may likewise be selected arbitrarily, once and forever, i.e. a vector that is fixed relative to the content). When the screen of the tablet is rectangular, its reference vector may be a vector connecting a corner of the rectangle defined by the screen to another corner on the same side of the rectangle. For each content, the reference value of the content may, for example, be a vector that is directed vertically from the bottom of the content towards the top of the content (clearly it is possible to decide once and forever that the vector should be a vector going horizontally from left to right, or in any direction at any angle defined arbitrarily, once and forever—but in the description below it is taken to be vertical, from bottom to top, by way of example). The content may be two-dimensional, and the bottom, the top, and the vertical of the content may be defined by the author of the content. The bottom, the top, and the vertical of the content may be determined by the format used for storing the data representing the content. For example, the content may be represented by an array of dots (e.g. in the form of a so-called “bitmap” image in the BMP format). In the BMP format, the pixels of the image are coded row by row starting from the bottom row of the image. The BMP format thus begins by specifying the bottom left dot of the image and then continues with the dot immediately adjacent on the right, and so on to the end of the bottom row. There follows the leftmost dot of the second row starting from the bottom, and so on to the rightmost dot of the row at the top of the image. The content may also be text having characters coded using an ASCII format beginning by the top left character, followed by the character immediately to its right and so on, new line characters serving to move on to the following line. The width of the ASCII text may then correspond to its longest line, and its height may correspond to the number of lines multiplied by the height of one line. Most content formats include an orientation that may be explicit or implicit. Starting from a single content format, it is then possible to define a vertical vector that is directed from the bottom towards the top of the content. For example, for a bitmap image of BMP type, the vector may be the vector connecting the bottom left dot to the top left dot of the same image. Likewise, for an ASCII text, the vector may be a vector perpendicular to the lines of text and directed from the bottom lines towards the top lines (or if there is only one line directed from the bottom of the characters towards the top of the characters).

In a possible variant, it is possible to correct a human error in the coding of the content. For example, a teacher may scan a photograph on paper while inadvertently placing the photograph upside-down in the scanner. On applying the digital image format produced by the scanner (e.g. a JPEG image), the image is displayed upside-down. It is possible to analyze the image with recognition software that is well known in the state of the art, and as a function of the result, to modify its orientation relative to the presumed orientation (derived solely from the format). Thus, face recognition software can recognize the orientation of a face and can automatically reorient the image so that the face is the right way up, and the same is true for landscapes, etc. It is possible to modify the files storing the digital image so that after modification the real orientation of the content is represented directly by its format. This is also possible for contents other than images (e.g. text, in particular rich text such as text in the rich text format (RTF) or HTML, etc.). In a variant, it is possible to rely on the intrinsic orientation of the storage format of the content even if analysis of the content reveals that it might not be the right way up (it might happen that the teacher has deliberately chosen to display an image upside-down). The teacher can thus activate or deactivate an option for automatically correcting the orientation of the content, e.g. with a button (or a check box, etc.) associated with suitable software.

The educational content is thus designed to be viewed with a preferred angle and a preferred direction (enabling the position of the body and in particular of the back and the neck to be optimized). For example, a landscape image is typically intended to be viewed with the sky at the top and the ground at the bottom. Likewise, a text is generally meant to be read from left to right, while the right way up (and not inclined at an angle or upside-down). This preferred angle and direction may be intrinsic to the data format used for representing the educational content, as mentioned above. Thus, by drawing segments in the following order between the following points: pupil's left eye; pupil's right eye; right end of a horizontal line of text displayed on the screen of the tablet for which the pupil is the identified user; left end of the same horizontal line of text; and back to the pupil's left eye; a plane figure should be drawn, and more precisely a convex isosceles trapezoid, when the pupil is in a comfortable position (implying that the pupil's torso is in a symmetrical configuration and that the plane of symmetry of the torso coincides with the plane of symmetry of the skull).

Nevertheless, the first and second orientations relate to the position of the tablet, while the position of the pupil relative to the position of the tablet is unknown, a priori. If the tablet is not properly located relative to the pupil, then the figure formed as specified in the above paragraph (and when the educational content is text presented in the usual manner) is not a convex isosceles trapezoid, but may for example be a non-isosceles convex trapezoid (if the pupil is offset to the right or the left of the tablet), a crossed quadrilateral (if the tablet is upside-down relative to the pupil), a non-trapezoidal quadrilateral, or indeed a three-dimensional figure. The pupil will then doubtless spontaneously move and/or turn the tablet in order to see the educational content in the manner most comfortable for the pupil. The need to orient the tablet as a function of a displayed image can in itself constitute an orientation exercise that is of interest from an educational point of view (on the same lines as pupils identifying themselves by clicking on their own name before using the tablet constitutes a name-recognition exercise that is often of interest). The first image to be displayed may be an image required for pupil identification. This first image may be a list of names from which the pupil must recognize his or her own name (in order to be connected). Depending on the configuration of the tablet, the list may be duplicated (one the right-way up, another upside-down), so that the list is easily readable both by a right-hander and by a left-hander. In another example, the list of names may be displayed once only but with an orientation that is equally good for a right-hander and for a left-hander. For example, with a tablet in which the only asymmetrical element is the stylus support, an orientation in which the stylus support is at the top or the bottom of the screen is equally ergonomic for right-handers and left-handers. In an example, a teacher may perform the initial operation of orienting the tablet for a pupil (if the pupil does not manage). The fact that the pupils might, where appropriate, need to reorient the tablet does not constitute a drawback.

The pupil (or the teacher on behalf of the pupil) thus needs to select an orientation for the tablet relative to the pupil (which orientation is determined by the first or second orientation imposed on the educational content relative to the tablet) that is defined as being ergonomic for the pupil as a function of the pupil's handedness.

In an example, the electronic system for providing assistance in teaching includes a display circuit arranged to select the first orientation so that the asymmetrical element is other than at the left of the screen when the tablet is oriented in this first orientation, and to select the second orientation so that the asymmetrical element is other than at the right of the screen when the tablet is oriented in the second orientation.

This is advantageous, in particular when the screen is not circularly symmetrical (when the screen is not a disk). Under such circumstances, depending on the format of the screen, and on the nature of the educational content to be displayed, it may not be possible to select the position of the asymmetrical element completely freely (i.e. there may exist only a limited number of possibilities), it then being possible merely to exclude the positions that are the most awkward.

For example, there exist only two possibilities for displaying an image of elliptical shape on a screen of elliptical shape and having the same dimensions. There exist only three possibilities for displaying an image contained in an equilateral triangle on a screen of shape corresponding to the same equilateral triangle, four possibilities with a square, two with a rectangle, etc.

With a screen of rectangular shape, and in a frame of reference having as axes one axis running along a small side of the rectangle surrounding the screen and another axis running along a long side of the rectangle surrounding the screen, an asymmetrical element may occupy specifically one of the following eight positions:

TR: above and to the right of the screen;

TL: above and to the left of the screen;

BR: below and to the right of the screen;

BL: below and to the left of the screen;

SB: below the screen and excluding the above-specified positions (“strictly” below);

ST: above the screen and excluding the above-specified positions (“strictly” above);

SL: to the left of the screen excluding the above-specified positions (“strictly” to the left); and

SR: to the right of the screen to the exclusion of the above-specified positions (“strictly” to the right).

The “right” position thus means: strictly to the right, above and to the right, or below and to the right.

The “left” position thus means: strictly to the left, above and to the left, or below and to the left.

The “above” position thus means: strictly above, above and to the left, or above and to the right.

The “below” position thus means: strictly below, below and to the left, or below and to the right.

In addition, for a rectangular screen, as mentioned there are only two possibilities for displaying a rectangular image having the same size as the screen.

Thus, there exist only two possible positions for the asymmetrical element that can be selected by changing orientation.

If it is the TR position, it may go to the BL position (and vice versa).

If it is in the TL position, it may go to the BR position (and vice versa).

If it is in the ST position, it may go to the SB position (and vice versa).

If it is in the SL position, it may go to the SR position (and vice versa).

For each possible position, it is appropriate to decide which is the least troublesome (or the most ergonomic).

In general, the positions to the right (be they TR, SR, or BR) or to the left (be they TL, SL, or BL) can turn out to be discriminatory, i.e. they can be troublesome for a pupil depending on whether the pupil is left- or right-handed, and it may be advantageous to avoid those positions.

In certain examples, only the positions SR and BR or SL and BL, as the case may be, are discriminatory (the top positions not being troublesome since they are typically not reached by the hand or the arm when the pupil places the dominant hand on the screen for writing).

In an example, a right-handed pupil must not have an asymmetrical element on the right (where it might be troublesome), and likewise a left-handed pupil must not have an asymmetrical element on the left (where it might be troublesome). For example, a teacher may decide not to use a stylus in classes with pupils who are less than four years old (since they are not sufficiently skillful with a stylus for a given type of exercise), and have them write directly with their fingers. Under such circumstances, the stylus carrier may be troublesome (even if the stylus has been removed) if it is on the same side as the pupil's dominant hand.

Conversely, when the teacher has the pupils write with a stylus (e.g. because they are at least four years old, or if the teacher is making children aged less than four years perform exercises that are easy with a stylus in order to familiarize them with this tool), it is on the contrary the fact that the pupil needs to look for the stylus on the left if the pupil is right-handed (and vice versa for the left-handed) that can be found to be troublesome. Thus, in an example, the system prefers a display in which the asymmetrical element is on the right for a right-handed pupil and on the left for a left-handed pupil.

In other examples, it may be that the positions SB or ST are discriminatory (but often for reasons that are independent of whether the pupil is right- or left-handed). For example, it may be troublesome for the pupil to catch on a large asymmetrical element in the SB position while writing on the screen, or on the contrary for the pupil to be obliged to stretch to the top of the screen in order to actuate an asymmetrical element in the ST position.

In certain configurations, both possible orientations (e.g. SB and ST) may be equally ergonomic (in which case they are not discriminatory). Under such circumstances, it is possible to select one of the two positions arbitrarily (or as described in detail below) to select one of the positions by involving additional parameters that are specific to the tablet).

In an example, the system has a configuration module (which may be integrated in the teaching computer, or if the teaching computer is associated with a server, in the server). Where appropriate, the configuration module contains a set of default configurations (preferring one orientation over another depending on the age of the pupils, on the type of the exercise, on a priority list among various different asymmetrical elements, etc.). The configuration module also enables teachers to define their own profiles (preferring, in a manner similar to the configuration by default, one orientation over another depending on the age of the pupils, on the type of the exercise, on a priority list from among various different asymmetrical elements, etc.). Personalized profiles may involve personalized types of exercise, or may make selections that are opposite to the selection by default under circumstances that are identical.

Thus, once a profile has been selected, the orientation of the tablets of the pupils is determined by the profile (depending on whether the pupils are right- or left-handed).

The left and the right of the screen may be defined as a function of the displayed content (meaning that there is a particular orientation of the tablet that enables the content to be seen correctly) for screens other than rectangular screens. These definitions can be understood intuitively, but it is also possible to define them mathematically.

For example, for a tablet having a surface that is plane with a plane screen of arbitrary shape, the left portion of the screen may be defined as follows. Initially, a left vector (L_V) is defined as being the vector that results from applying a vector rotation to the reference vector of the screen through an angle equal to the selected orientation (first or second orientation) plus 90°. Thereafter, the left periphery of the screen is defined as being a set of points L_PER_PT of the screen such that for any strictly positive scalar k, L_PER_PT+k*L_V is not a point of the screen. Finally, the left of the screen is defined as being the zone of the tablet defined by the set of points L_ZONE_PT of the tablet such that there exists a strictly positive scalar k such that L_ZONE_PT=L_PER_PT+k*L_V. The zone other than to the left of the screen then designates the zone other than the screen and other than to the left of the screen.

Likewise, the right portion of the screen may be defined as follows. Initially, a right vector (R_V) is defined as being the vector that results from applying a vector rotation to the reference vector of the screen through an angle equal to the selected orientation (first or second orientation) minus 90°. Thereafter, the right periphery of the screen is defined as being a set of points R_PER_PT of the screen such that for any strictly positive scalar k, R_PER_PT+k*R_V is not a point of the screen. Finally, the right of the screen is defined as being the zone of the tablet defined by the set of points R_ZONE_PT of the tablet such that there exists a strictly positive scalar k such that R_ZONE_PT=R_PER_PT+k*R_V. The zone other than to the right of the screen then designates the zone other than the screen and other than to the right of the screen.

The above definitions of left and right are definitions for strictly left and strictly right in the meaning of the examples given above for rectangular screens (SR and SL).

In an example, the electronic system for providing assistance in teaching includes a tablet having a screen that is substantially rectangular and in which the asymmetrical element lies in a half-plane defined by an axis passing through one of the short sides of the rectangle corresponding to the screen and not including the rectangle.

When the display is configured in landscape mode, and if the value of the handedness parameter of the current user of the tablet as determined by the user identification circuit of the tablet is a first one of two handedness parameter values, the display circuit is arranged to select as its first orientation an orientation such that the asymmetrical element lies on the right of the screen (for a pupil located in front of the screen so as to view the educational content in appropriately oriented manner). That the manner in which the educational content is oriented is appropriate may be assessed in particular on the basis of educational content consisting of text, with the above-described convex isosceles trapezoid test. The first orientation may correspond to no rotation of the educational content if the asymmetrical element is already on the right of the screen for a conventional display (e.g. a first orientation not modifying the display by default), and to rotating the educational content through 180° if the asymmetrical element is on the left of the screen.

In contrast, if the handedness parameter takes the second of the two values for the handedness parameter, the display circuit is arranged to select as its second orientation an orientation such that the asymmetrical element is on the left of the screen (for a pupil placed in front of the screen so as to view the educational content in appropriately oriented manner). This second orientation may correspond to no rotation of the educational content if the asymmetrical element is already on the left of the screen for a conventional display (i.e. a second orientation that does not modify the display by default), and to a rotation of the educational content through 180° if the asymmetrical element is on the right of the screen.

In an example, the display circuit is itself arranged to configure the screen in landscape mode (i.e. so that the width of the display area is greater than its height), either on command (e.g. by a teacher), or as a function of the transmitted educational content. In an example, the system identifies the educational content as landscape mode content by using the data format used for representing the content. This format can thus indicate that the content is wider than it is high (e.g. a bitmap image having more pixels per row than it has rows). In an example, the educational content is defined as being landscape mode content by analyzing the type of content or what the content represents. For example, an ASCII text may have only one line (possibly a very long line) per paragraph (using new line signs only to go from one paragraph to the next) and the display circuit may match the text to the dimensions of the screen by automatically adding new line signs each time the end of a screen line is reached (which amounts to redimensioning the text). An ASCII text can then be arranged to be displayed in a mode by default (e.g. in landscape mode). In another example, the system may take account of the number of words in the ASCII text in order to select a display in landscape mode. Thus, an ASCII text that is very short (e.g. a sentence of fewer than ten words, may be displayed by default in landscape mode using large characters.

In an example, the educational content is defined as landscape mode content with a parameter that is integrated in (or associated with) the educational content and that specifies that landscape mode is required, or at least is more appropriate. The parameter may constitute one or more items of metadata associated with the content and specifying the desired display mode (e.g. landscape mode). The system is then arranged to configure the display automatically in landscape mode.

Naturally, when the dimensions of the content do not correspond exactly to the dimensions of the screen, it is possible in conventional manner to proceed either with scaling the content (zooming out or zooming in until the content is displayed in full and occupies a maximum area of the screen), or else the content may be truncated (excluding non-essential portions that lie beyond the screen, as is done for example when truncating cinema films in 16/9 format).

In contrast, in the event that the system is configured in portrait mode, there is no guarantee that it is possible to select a left or a right position for the asymmetrical element. When it is not possible for the element to be placed on the right or on the left (i.e. when the asymmetrical element is in the ST or SB positions), one needs to select between the ST position and the SB position. When the applicable personalized profile (or default configuration) of the configuration module (or any other technique used for setting the rules that are to be applied when selecting orientation) specifies that one of the SB or ST positions is preferable in the context under consideration, the system may be arranged to select that position (where appropriate by applying a rotation through 180°).

Otherwise, one of the two positions may be selected by default (e.g. the ST position).

It is also possible to provide the following provisions for selecting between SB and ST. The tablets may be fitted with gyros (such as gyros of microelectromechanical system (MEMS) type). The gyro can measure the yaw angle (rotation about a vertical axis of the class). In an example, the tablets are all stored with the same attitude in a stationary docking station (that also serves to recharge their batteries) while they are not in use. The term “attitude” specifies, in three dimensions, the directions of the three reference axes of an article relative to a reference frame. Each time a tablet is stored in the docking station, its gyro is reset to zero (to correct for drift of the gyro over time). The tablet is generally stored in this manner at least once every day since it is difficult to imagine the tablet being kept in disorganized manner for longer than a day. The tablets are stored, if only to enable them to be recharged by the station. Conventional classroom plans often have rows of pupils all facing towards the teacher. All of the pupils' tables are then parallel, and the pupils are all oriented in the same manner. The configuration module may be arranged to enable this orientation to be stored. By way of example, the teacher may identify his- or herself with a tablet using a configuration identifier (instead of a pupil identifier), and the gyro of the tablet should preferably just have been reinitialized in the docking station. The teacher can then place this tablet on a pupil's table with the tablet oriented in the pupils to teacher direction. The tablet may display a large arrow on the screen pointing to a symbolic representation of the teacher and with a symbolic representation of the pupils at its base in order to make the manipulation more intuitive. The teacher can then click on a link to transmit information from the reference gyro to the teaching computer. The gyro of a tablet can thus identify the yaw angle corresponding to a blackboard orientation (from the pupils to the teacher). Given the current orientation of the tablet, it is then possible to determine whether it is possible to minimize the rotation of the tablet by a pupil by selecting from among the two positions SB and ST that one which gives rise to the least rotation of the tablet.

In particular, if one of the positions SB and ST makes it possible to avoid any rotation, that position is selected. This situation is quite probable with a screen that is rectangular and that has only four potentially correct orientations for conventional applications (two in portrait mode and two in landscape mode). It is probable that a pupil will not orient a tablet at an angle other than 0°, 90°, 180°, or 270°, since those are the orientations that are the most natural. The use of the gyro thus makes it possible under certain circumstances to select the proper orientation without any need for the pupil to turn the tablet (by selecting between no rotation and rotation through 180°). Rotation through 90° may be necessary if the tablet is put in portrait orientation when it is to display landscape mode content, or vice versa.

In an example, the tablets include not only a gyro but also accelerometers for measuring position in at least one horizontal plane of the classroom (by double integration). In this example, the teaching computer is (or includes) a laptop computer used by the teacher (or the teacher may use a tablet of the same type as those used by the pupils). The teacher's computer also has accelerometers for measuring position at least in a horizontal plane of the classroom, and these accelerometers (like those of the tablets) are regularly reinitialized in the stationary docking station. The configuration module may be arranged to operate in the context of a non-conventional classroom layout (with an arbitrary distribution of tables, it being possible for some tables to surround the teacher, for example, or for tables to be arranged in groups that might possibly be of different sizes). Knowing its position, each tablet can determine the theoretical orientation of the pupil (vector going from the position of the tablet towards the theoretical position of the teacher, corresponding to the position of the laptop computer) and can thus select between the positions SB and ST, that one which requires least rotation (or as mentioned above that one which sometimes requires no rotation of the tablet as opposed to that one which requires rotation through 180°).

Furthermore, by having gyros and accelerometers integrated in the tablets it is possible to obtain other functions, in particular creating a plan of the classroom facilitating supervision of the class (e.g. a class supervision circuit, instead of displaying a list of pupils sorted alphabetically, may alternatively display a plan of the classroom corresponding to the real positions of the pupils in the classroom).

Instead of using gyros and/or accelerometers, or in addition to using them, the control module may include an interface enabling the orientation of a tablet to be forced from the teaching computer when a plurality of orientations are possible (SB and ST).

The teacher can thus see how the tablet(s) of one or more pupils is/are oriented, and instead of going up to the pupil's table, the teacher can change the orientation of the display merely by means of a click if the display was SB instead of ST (or vice versa) when both of those positions are possible.

In an example, an electronic system for providing assistance in teaching includes a tablet with a screen that is substantially rectangular and the asymmetrical element lies in a half-plane defined by an axis running along one of the long sides of the rectangle corresponding to the screen and not including the rectangle.

When the display is configured in portrait mode, and if the handedness parameter of the current user of the tablet as determined by the user identification circuit of the tablet takes a first one of two handedness parameters, the display circuit is arranged to select as its first orientation an orientation such that the asymmetrical element lies on the right of the screen (for a pupil located in front of the screen so as to view the educational content in appropriately oriented manner). The first orientation may correspond to no rotation of the educational content if the asymmetrical element is already on the right of the screen for a conventional display (e.g. a first orientation not modifying the display by default), and to rotating the educational content through 180° if the asymmetrical element is on the left of the screen.

In contrast, if the handedness parameter takes the second of the two values for the handedness parameter, the display circuit is arranged to select as its second orientation an orientation such that the asymmetrical element is on the left of the screen (for a pupil placed in front of the screen so as to view the educational content in appropriately oriented manner). This second orientation may correspond to no rotation of the educational content if the asymmetrical element is already on the left of the screen for a conventional display (i.e. a second orientation that does not modify the display by default), and to a rotation of the educational content through 180° if the asymmetrical element is on the right of the screen.

In an example, the display circuit is itself arranged to configure the screen in portrait mode (i.e. so that the height of the display area is greater than its width), either on command (e.g. by a teacher), or as a function of the transmitted educational content. In an example, the system identifies the educational content as portrait mode content by using the data format used for representing the content. This format can thus indicate that the content is taller than it is wide (e.g. a bitmap image having more rows than pixels per row). In an example, the educational content is defined as being portrait mode content by analyzing the type of content or what the content represents. For example, an ASCII text may have only one line (possibly a very long line) per paragraph (using new line signs only to go from one paragraph to the next) and the display circuit may match the text to the dimensions of the screen by automatically adding new line signs each time the end of a screen line is reached (which amounts to redimensioning the text). An ASCII text can then be arranged to be displayed in a mode by default (e.g. in portrait mode). In another example, the system may take account of the number of words in the ASCII text in order to select a display in portrait mode. Thus, an ASCII text which is very long (e.g. having more than one thousand characters) may be displayed by default in portrait mode. For example, the educational content is defined as portrait mode content with a parameter that specifies that portrait mode is required, or at least is more appropriate. The parameter may constitute one or more items of metadata associated with the content and specifying the desired display mode (e.g. portrait mode). The system is then arranged to configure the display in portrait mode.

In contrast, in the event that the system is configured in landscape mode, there is no guarantee that it is possible to select a left or a right position for the asymmetrical element. When it is not possible for the element to be placed on the right or on the left (i.e. when the asymmetrical element is in the ST or SB positions), ones needs to select between the ST position and the SB position. When the applicable personalized profile (or default configuration) of the configuration module (or any other technique used for setting the rules that are to be applied when selecting orientation) specifies that one of the SB or ST positions is preferable in the context under consideration, the system may be arranged to select that position (where appropriate by applying a rotation through 180°).

Otherwise, one of the two positions may be selected by default (e.g. the ST position).

It is also possible to provide the provisions set out in the previously-described implementation, and make use of a gyro and/or accelerometers. Between the positions SB and ST, the system may thus select that one which requires the least rotation (or as mentioned above that one which, sometimes, requires no rotation as opposed to that one which requires rotation through 180°).

When the two rotations for reaching SB or for reaching ST are equivalent (i.e. if the tablet is in landscape mode and it is portrait mode that is requested), it is possible to select one or the other randomly and then if the pupil turns in the wrong direction, to correct automatically by selecting the other position. This is naturally also possible with a tablet that is oriented in portrait mode when it should have been oriented in landscape mode.

In an example, the display circuit is arranged to display educational content having various different elements. The system has a graphical interface circuit arranged to arrange the various elements of the educational content on the screen of one of the tablets in a manner that varies depending on whether the handedness parameter of the current user of the tablet, as determined by the user identification circuit of the tablet, takes the first or the second of the two values of the handedness parameter. For example, the tablet may display a virtual keyboard on the screen so that the pupil can click on the displayed letters in order to write them. The keyboard may be placed either on one side of the screen or on the other depending on whether the pupil is left- or right-handed. Thus, not only are the tablets of a right-hander and of a left-hander not necessarily oriented in the same manner, but the content displayed thereon may also be different. It is possible to organize a hierarchy of the various elements of the content to be displayed. Those which are the most important (e.g. instructions for an exercise) may be displayed in a zone of the screen that is the least likely to be hidden by the pupil's hand (given the pupil's handedness), whereas elements that are less important may be placed in zones that are more likely to be seen less well by the pupil (e.g. bottom right of the screen for a right-handed pupil).

The graphical interface circuit may be a processor (it may even be an already existing processor of a tablet or of the teaching computer, such as its main processor), associated with a memory storing a program adapted to performing the educational content display procedure. The circuit may also be a dedicated electronic circuit such as an ASIC or an FPGA, or an electronic circuit made entirely to measure, or a dedicated microcontroller. It may also be a combination of a component of the tablet and a component of the teaching computer.

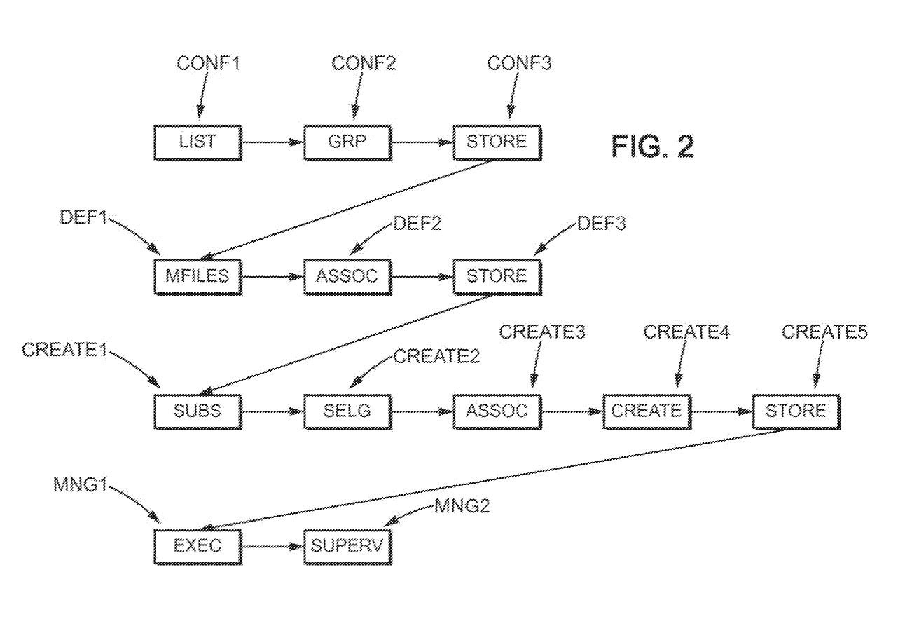

FIG. 2 is a diagram illustrating an example of a method for performing the following steps.

During a step CONF1, a task configuration circuit defines a list of pupils. During a step CONF2, it defines a group of pupils selected from the pupils in the list. During a step CONF3, it stores the list of pupils and the group(s) of pupils on a teaching computer.

During a step DEF1, an educational content definition circuit defines multimedia files, each representing an educational lesson. During a step DEF2, it associates metadata with each of these multimedia files to enable the multimedia files to be sorted. During a step DEF3, it stores the multimedia files and the associated metadata on the teaching computer.

During a step CREATE1, an educational session creation circuit selects from the multimedia files defined by the educational content definition circuit a subset of multimedia files suitable for use during a given educational session. During a step CREATE2 it selects at least one group of pupils from the group(s) defined by the task configuration circuit. During a step CREATE3 it associates one or more multimedia files selected from the subset of multimedia files with each group of pupils selected in this way. During a step CREATE4 it creates a second file specifying the selected groups and the multimedia file(s) associated with each of the selected groups. During a step CREATE5 it stores the session file on the teaching computer.

During a step MNG1, an educational session management circuit for a session file launches execution of the session file, which includes for each group specified in the session file triggering execution of the associated multimedia file(s). During a step MNG2 it continues this execution, which includes the teaching computer supervising the execution of the associated multimedia file(s).

In an example, an electronic method for providing assistance in teaching is performed by a system (such as a system of any one of the above-described examples). The system includes: a teaching computer; a plurality of wireless tablets, each having a screen and a user identification circuit; a docking station arranged to dock the plurality of wireless tablets in order to charge in parallel the batteries of the plurality of wireless tablets; a class configuration circuit; an educational content definition circuit; an educational session creation circuit; and an educational session management circuit.

The method includes the class definition circuit defining, on the basis of inputs performed on the system by a teacher using the system, a list of pupils and at least one group of pupils selected from the pupils of the list of pupils, and storing on the teaching computer both the list of pupils and also the group(s) of pupils.

The method includes, on the basis of inputs performed on the system by a teacher using the system, the educational content definition circuit defining multimedia files each representing an educational lesson, associating at least one item of metadata with each of the multimedia files to enable the multimedia files as defined in this way to be sorted, and storing on the teaching computer the multimedia files and the associated metadata.

The method includes, on the basis of inputs performed on the system by a teacher using the system, the educational session creation circuit defining a subset of multimedia files form the multimedia files defined by the educational content definition circuit, which multimedia files of the subset may be used during a given educational session, selecting at least one group of pupils from the group(s) defined by the class configuration circuit, associating one or more multimedia files selected from the subset of multimedia files with each group of pupils selected in this way, creating a session file specifying the selected groups and the multimedia file(s) associated with each of the selected groups, and storing the session file on the teaching computer.

The method includes, on the basis of inputs performed on the system by a teacher using the system, the educational session management circuit executing a session file, the execution of the session file including, for each group specified in the session file, triggering execution of the associated multimedia file(s) and the teaching computer supervising the execution of the associated multimedia file(s), the execution of the associated multimedia file(s) including the teaching computer sending to all of the wireless tablets with identification circuits that have identified their users as being pupils of the group, educational content corresponding to the associated multimedia file(s), and managing the educational content by each of the wireless tablets.

In an example, a computer program includes a series of instructions performing the method according to any of the implementations when the instructions are executed on one or more processors. The program may be written in particular in assembly language, in C, in Java, in C#, or in any other appropriate language. The language may be different for a program portion situated in a tablet and for a program portion situated in the teaching computer or in the various circuits.

In an example, a non-transitory computer-readable storage medium stores a program as set out in the paragraph above. The storage medium may be a rewritable memory (e.g. of the electrically erasable programmable read-only memory (EEPROM) or flash memory type or of the battery-backed-up random access memory (RAM) type) or it may be non-rewritable memory (e.g. memory of the read-only memory (ROM) type). The memory may be integrated in a tablet, either directly on its motherboard, or in the form of a memory card (such as a micro-SD or other card). The storage medium may also be a magnetic medium of the hard disk type (possibly incorporated within a teaching computer).

The invention is not limited to the embodiments described above by way of example; it extends to other variants.

Certain improvements are independent of one another, e.g. the docking station with means for synchronizing the accelerometers (and gyros if any) of the tablets may be used independently of the other aspects. It is possible to devise solutions constituting alternatives to accelerometers (e.g. triangulation based on transmitters arranged in the classroom and receivers installed in the tablets, with this solution being less flexible in use and more complex to install but being potentially more accurate and having substantially no drift).

Implementations relating to the methods may be transposed to the systems, and vice versa.

1-10. (canceled)

11. An electronic system for providing assistance in teaching, the system comprising:
a teaching computer;
a plurality of wireless tablets, each comprising a screen and a user identification circuit;
a docking station arranged to receive the plurality of wireless tablets and to enable the batteries of the plurality of wireless tablets to be charged in parallel;
a class configuration circuit arranged to define a list of pupils and at least one group of pupils selected from the pupils of the list of pupils, and to store on the teaching computer firstly the list of pupils and secondly the at least one group of pupils;
an educational content definition circuit arranged to define multimedia files, each representing an educational lesson, to associate each of the multimedia files with at least one item of metadata enabling the multimedia files as defined in this way to be sorted, and to store the multimedia files and the associated metadata on the teaching computer;
an educational session creation circuit arranged to define, on the basis of the multimedia files defined by the educational content definition circuit, a subset of multimedia files suitable for use during a given educational session, to select at least one group of pupils from the at least one group of pupils defined by the class configuration circuit, to associate one or more multimedia files selected from the subset of multimedia files with each of the selected at least one group of pupils, to create a session file specifying the selected at least one group of pupils and the one or more multimedia files associated with each of the at least one selected groups, and to store the session file on the teaching computer; and
an educational session management circuit (MNG) arranged to cause the session file to be executed, the execution of the session file comprising for each of the specified at least one groups in the session file, executing the associated one or more multimedia file and the teaching computer supervising the execution of the associated one or more multimedia file, the execution of said associated one or more multimedia files comprising the teaching computer sending educational content corresponding to the associated one or more multimedia files to each of the wireless tablets that have with their identification circuits identified their users as being pupils of the group, and each of the wireless tablets managing the educational content.

12. The system of claim 11, wherein the teaching computer is arranged to supervise the execution of the one or more multimedia files using one of the plurality of wireless tablets by displaying on a screen of the teaching computer a copy of the display of the wireless tablets, and by displaying on the screen of the wireless tablets information input by a teacher using the teaching computer as a function of the displaying on a screen of the teaching computer.

13. The system of claim 11, wherein the teaching computer is arranged to virtualize the environment of each of the wireless tablets and to thus execute the one or more multimedia files on behalf of each of the wireless tablets, each of the wireless tablets receiving display information from the teaching computer to display the educational content that is to appear on the screen of the wireless tablet, the management of the educational content by the wireless tablet comprising transmitting touch information input by the pupil on the wireless tablet to the teaching computer.

14. The system of claim 12, wherein the teaching computer is arranged to virtualize the environment of each of the wireless tablets and to thus execute the one or more multimedia files on behalf of each wireless tablet, each wireless tablet receiving display information from the teaching computer to display the educational content that is to appear on the screen of the wireless tablet, the management of the educational content by the wireless tablet comprising transmitting touch information input by the pupil on the wireless tablet to the teaching computer.

15. The system of claim 11, wherein the sending, by the teaching computer, of educational content corresponding to the associated one or more multimedia files to all of the wireless tablets that have identified their users as being pupils of the group by means of their identification circuit, comprises sending the one or more multimedia files to each of the wireless tablets, wherein the management of the educational content by each of the wireless tablets comprises each of the wireless tablets executing the one or more multimedia files, and wherein the teaching computer is arranged to supervise the execution of the one or more multimedia files by a given wireless tablet by itself executing the same one or more multimedia files and obtaining from the wireless tablets a copy of the touch inputs made by the pupil on the wireless tablet.

16. The system of claim 12, wherein the sending, by the teaching computer, of educational content corresponding to the one or more associated multimedia files to all of the wireless tablets that have identified their users as being pupils of the group by means of their identification circuit, comprises sending said one or more multimedia files to each of the wireless tablets, wherein the management of said educational content by each of the wireless tablets comprises each of the wireless tablets executing the one or more multimedia files, and wherein the teaching computer is arranged to supervise the execution of the one or more multimedia files by a given wireless tablet by itself executing the same one or more multimedia files and obtaining from the wireless tablets a copy of the touch inputs made by the pupil on the wireless tablet.

17. The system of claim 11, wherein the teaching computer is arranged to supervise the execution of the one or more multimedia files by interrupting the execution of the one or more multimedia files on at least one of the wireless tablets.

18. The system of claim 12, wherein the teaching computer is arranged to supervise the execution of the one or more multimedia files by interrupting the execution of the one or more multimedia files on at least one of the wireless tablets.

19. The system of claim 13, wherein the teaching computer is arranged to supervise the execution of the one or more multimedia files by interrupting the execution of the one or more multimedia files on at least one of the wireless tablets.

20. The system of claim 14, wherein the teaching computer is arranged to supervise the execution of the one or more multimedia files by interrupting the execution of the one or more multimedia files on at least one of the wireless tablets.

21. The system of claim 15, wherein the teaching computer is arranged to supervise the execution of the one or more multimedia files by interrupting the execution of the one or more multimedia files on at least one of the wireless tablets.

22. The system of claim 16, wherein the teaching computer is arranged to supervise the execution of the one or more multimedia files by interrupting the execution of the one or more multimedia files on at least one of the wireless tablets.

23. The system of claim 17, wherein the educational session creation circuit arranged for creating a subset of multimedia files and the session file is arranged so that the session file also specifies the subset, and wherein the teaching computer is arranged to supervise the execution of the one or more interrupted multimedia files by selecting one of the multimedia files of the subset defined in the session file, and by causing the file to be executed by at least one of the wireless tablets.

24. The system of claim 18, wherein the educational session creation circuit arranged for creating a subset of multimedia files and the session file is arranged so that the session file also specifies the subset, and wherein the teaching computer is arranged to supervise the execution of the one or more interrupted multimedia files by selecting one of the multimedia files of the subset defined in the session file, and by causing the file to be executed by at least one of the wireless tablets.

25. The system of claim 19, wherein the educational session creation circuit arranged for creating a subset of multimedia files and the session file is arranged so that the session file also specifies the subset, and wherein the teaching computer is arranged to supervise the execution of the one or more interrupted multimedia files by selecting one of the multimedia files of the subset defined in the session file, and by causing the file to be executed by at least one of the wireless tablets.

26. The system of claim 20, wherein the educational session creation circuit arranged for creating a subset of multimedia files and the session file is arranged so that the session file also specifies the subset, and wherein the teaching computer is arranged to supervise the execution of the one or more interrupted multimedia files by selecting one of the multimedia files of the subset defined in the session file, and by causing the file to be executed by at least one of the wireless tablets.

27. The system of claim 11, further comprising an interaction whiteboard or a video projector, the management circuit being arranged to use the interactive whiteboard or the video projector to display the multimedia content resulting from the execution of a multimedia file.

28. A method of electronically providing assistance in teaching, the method performed by a system comprising a teaching computer, a plurality of wireless tablets, each comprising a screen and a user identification circuit, a docking station arranged to receive the plurality of wireless tablets and to enable batteries of the plurality of wireless tablets to be charged in parallel, a class configuration circuit, an educational content definition circuit, an educational session creation circuit, and an educational session management circuit, the method comprising:
using the class configuration circuit, defining a list of pupils and at least one group of pupils selected from the pupils of the list of pupils, and storing on the teaching computer both the list of pupils and the at least one group of pupils;
using the educational content definition circuit, defining multimedia files, each representing an educational lesson, associating at least one item of metadata with each of the defined multimedia files enabling the defined multimedia files to be sorted, and storing the multimedia files and the associated metadata on the teaching computer;
using the educational session creation circuit, defining a subset of multimedia files suitable for being used during a given educational session on the basis of the multimedia files defined by the educational content definition circuit, selecting at least one group of pupils from the at least one group defined by the class configuration circuit, associating one or more multimedia files selected from the subset of multimedia files with each of the selected at least one group of pupils, creating a session file specifying the at least one selected group and the one or more multimedia files associated with each of the at least one selected group, and storing the session file on the teaching computer; and
using the educational session management circuit, executing a session file, the execution of the session file comprising, for each group specified in the session file, triggering the execution of the associated one or more multimedia files and the teaching computer supervising the execution of the one or more associated multimedia files, the execution of the associated one or more multimedia files comprising the teaching computer sending educational content corresponding to the one or more associated multimedia files to all of the wireless tablets that have, with their identification circuits, identified their users as being pupils of the group, and each of the wireless tablets managing the educational content.

29. A computer program comprising a series of instructions performing the method according to claim 28 in response to the instructions being executed on one or more processors.

30. A non-transitory computer readable storage medium comprising the computer program according to claim 29.
